(19) United States
(12) Patent Application Publication
(10) Pub. No.: US 2024/0196241 A1
(43) Pub. Date: Jun. 13, 2024

(54) RADIO LINK MONITORING IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 18/520,364

(22) Filed: Nov. 27, 2023

Related U.S. Application Data
(60) Provisional application No. 63/431,983, filed on Dec. 12, 2022.
(60) Provisional application No. 63/442,959, filed on Feb. 2, 2023.

(51) Int. Cl. H04W 24/08

(52) U.S. Cl. CPC H04W 24/08

(57) ABSTRACT

A method includes receiving information for a set of radio link monitoring (RLM) reference signals (RSs) corresponding to a first subset of slots on a cell and a first set of parameters associated with an evaluation of the set of RLM RSs and receiving the set of RLM RSs. The method further includes determining a first reception quality for a RLM RS from the first set of RLM RSs; determining, based on the first reception quality and an adjustment value, a second reception quality for a second subset of slots from the set of slots; and determining a radio link failure for the second subset of slots when the second reception quality is below a reception quality threshold for a time period. The second subset of slots includes time-domain resources indicated for simultaneous transmission and reception on the cell and slots from the first subset of slots does not.

### CROSS-REFERENCE TO RELATED APPLICATION AND CLAIM OF PRIORITY

This application claims priority under 35 U.S.C. § 119(e) to U.S. Provisional Patent Application No. 63/431,983 filed on Dec. 12, 2022, and to U.S. Provisional Patent Application No. 63/442,959 filed on Feb. 2, 2023. The above-identified provisional patent application is hereby incorporated by reference in its entirety.

### TECHNICAL FIELD

The present disclosure relates generally to wireless communication systems and, more specifically, relates to radio link monitoring in full-duplex (FD) systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to radio link monitoring in full-duplex systems.

In an embodiment, a method of operating a user equipment (UE) includes receiving information for a set of radio link monitoring (RLM) reference signals (RSs) and a first set of parameters associated with an evaluation of the set of RLM RSs and receiving the set of RLM RSs. The set of RLM RSs corresponds to a first subset of slots from a set of slots on a cell. The method further includes determining, based on the first set of parameters, a first reception quality for a RLM RS from the first set of RLM RSs; determining, based on the first reception quality and an adjustment value, a second reception quality for a second subset of slots from the set of slots on the cell; and determining a radio link failure for the second subset of slots when the second reception quality is below a reception quality threshold for a second time period. Slots from the first subset of slots do not include time-domain resources indicated for simultaneous transmission and reception on the cell. Slots from the second subset of slots include time-domain resources indicated for simultaneous transmission and reception on the cell.

In another embodiment, a UE is provided. The UE includes a transceiver configured to receive information for a set of RLM RSs and a first set of parameters associated with an evaluation of the set of RLM RSs and receive the set of RLM RSs. The set of RLM RSs corresponds to a first subset of slots from a set of slots on a cell. The UE further includes a processor operably coupled with the transceiver. The processor is configured to determine, based on the first set of parameters, a first reception quality for a RLM RS from the first set of RLM RSs; determine, based on the first reception quality and an adjustment value, a second reception quality for a second subset of slots from the set of slots on the cell; and determine a radio link failure for the second subset of slots when the second reception quality is below a reception quality threshold for a second time period. Slots from the first subset of slots do not include time-domain resources indicated for simultaneous transmission and reception on the cell. Slots from the second subset of slots include time-domain resources indicated for simultaneous transmission and reception on the cell.

In yet another embodiment, a base station (BS) is provided. The BS includes a transceiver configured to transmit information for a set of RLM RSs and a first set of parameters associated with an evaluation of the set of RLM RSs and transmit the set of RLM RSs. The set of RLM RSs corresponds to a first subset of slots from a set of slots on a cell. A radio link failure for a second subset of slots from the set of slots on the cell is based on a second reception quality for the second subset of slots, that is based on a first reception quality for a RLM RS from the first set of RLM RSs and an adjustment value, is below a reception quality threshold for a second time period. Slots from the first subset of slots do not include time-domain resources indicated for simultaneous transmission and reception on the cell. Slots from the second subset of slots include time-domain resources indicated for simultaneous transmission and reception on the cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station according to embodiments of the present disclosure;

FIG. 3 illustrates an example user equipment (UE) according to embodiments of the present disclosure;

FIGS. 4A-B illustrate example wireless transmit and receive paths according to embodiments of the present disclosure;

FIG. 5 illustrates a transmitter block diagram for a physical downlink shared channel (PDSCH) in a slot according to embodiments of the present disclosure;

FIG. 6 illustrates a receiver block diagram for a PDSCH in a slot according to embodiments of the present disclosure;

FIG. 7 illustrates a transmitter block diagram for a physical uplink shared channel (PUSCH) in a slot according to embodiments of the present disclosure;

FIG. 8 illustrates a receiver block diagram for a PUSCH in a slot according to embodiments of the present disclosure;

FIG. 9 illustrates an example antenna blocks or arrays forming beams according to embodiments of the present disclosure;

FIG. 10 illustrates an example uplink/downlink (UL-DL) frame configuration in a time-division duplex (TDD) communication system configuration in accordance with various embodiments of this disclosure;

FIG. 11 illustrates an example UL-DL frame configurations in a FD communication system, in accordance with various embodiments of this disclosure;

FIG. 12 illustrates an example a full-duplex communication system using an offset or scaling value as an adjustment factor for radio link monitoring of SBFD slots or symbols, in accordance with embodiments of this disclosure;

FIG. 13 illustrates an example diagram of a full-duplex communication system using out-of-sync and in-sync block error rate(s) as adjustment factor for radio link monitoring of SBFD slots or symbols, in accordance with embodiments of this disclosure;

FIG. 14 illustrates an example process flowchart of a full-duplex communication system using an adjustment factor for radio link monitoring of SBFD slots or symbols, in accordance with embodiments of this disclosure;

FIG. 15 illustrates an example diagram of a full-duplex communication system using two RLM-RS resources configured with separate out-of-sync and in-sync block error rates, in accordance with embodiments of this disclosure;

FIG. 16 illustrates an example diagram of a full-duplex communication system using two RLM-RS groups associated with separate parameter sets, in accordance with embodiments of this disclosure;

FIG. 17 illustrates an example diagram of a full-duplex communication system using an RLM-RS subset, in accordance with embodiments of this disclosure;

FIG. 18 illustrates an example process flowchart of a full-duplex communication system using an RLM-RS subset to evaluate radio link quality, in accordance with embodiments of this disclosure;

FIG. 19 illustrates an example process flowchart of a full-duplex communication system using a slot/symbol type to select an RLM-RS subset, in accordance with embodiments of this disclosure;

FIG. 20 illustrates an example process flowchart of a full-duplex communication system using an RLM-RS subset to indicate secondary radio link monitoring failure or re-establishment, in accordance with embodiments of this disclosure;

FIG. 21 illustrates an example diagram of a fallback operation in a full-duplex communication system according to embodiments of the disclosure, in accordance with embodiments of this disclosure;

FIG. 22 illustrates an example process flowchart of a fallback operation in a full-duplex communication system according to embodiments of the disclosure, in accordance with embodiments of this disclosure;

FIG. 23 illustrates an example diagram of a full-duplex communication system using PDCCH-based or CSI report-based radio link quality evaluation according to embodiments of the disclosure, in accordance with embodiments of this disclosure;

FIG. 24 illustrates an example diagram of a full-duplex communication system using PDCCH-based or CSI report-based radio link quality evaluation according to embodiments of the disclosure, in accordance with embodiments of this disclosure.

### DETAILED DESCRIPTION

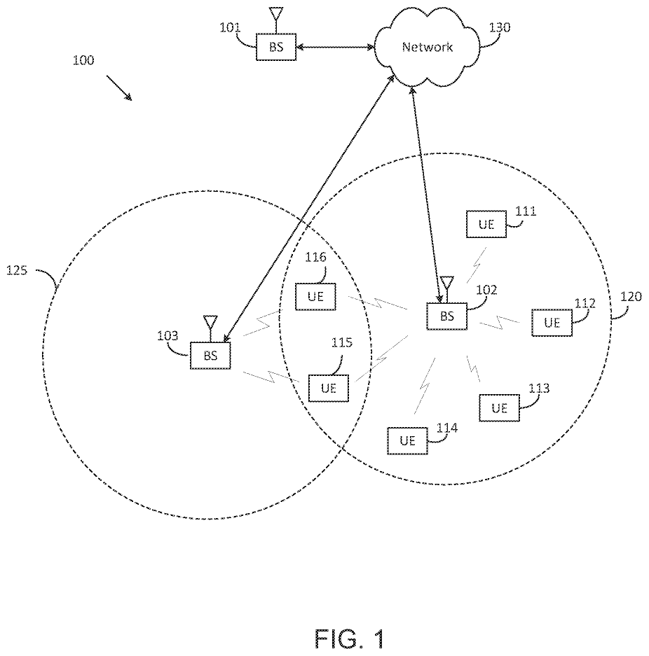

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein.: 3GPP TS 38.211 v17.2.0, “NR; Physical channels and modulation” (REF1); 3GPP TS 38.212 v17.2.0, “NR; Multiplexing and Channel coding” (REF2); 3GPP TS 38.213 v17.2.0, “NR; Physical Layer Procedures for Control” (REF3); 3GPP TS 38.214 v17.2.0, “NR; Physical Layer Procedures for Data” (REF4); 3GPP TS 38.321 v17.1.0, “NR; Medium Access Control (MAC) protocol specification” (REF5); 3GPP TS 38.331 v17.1.0, “NR; Radio Resource Control (RRC) Protocol Specification” (REF6); 3GPP TS 38.306 v17.1.0, “NR; User Equipment (UE) radio access capabilities” (REF7); and 3GPP TS 38.133 v17.2.0, “NR; Requirements for support of radio resource management” (REF8).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for radio link monitoring in FD systems. In certain embodiments, one or more of the BSs 101-103 include circuitry, programing, or a combination thereof to support radio link monitoring in FD systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

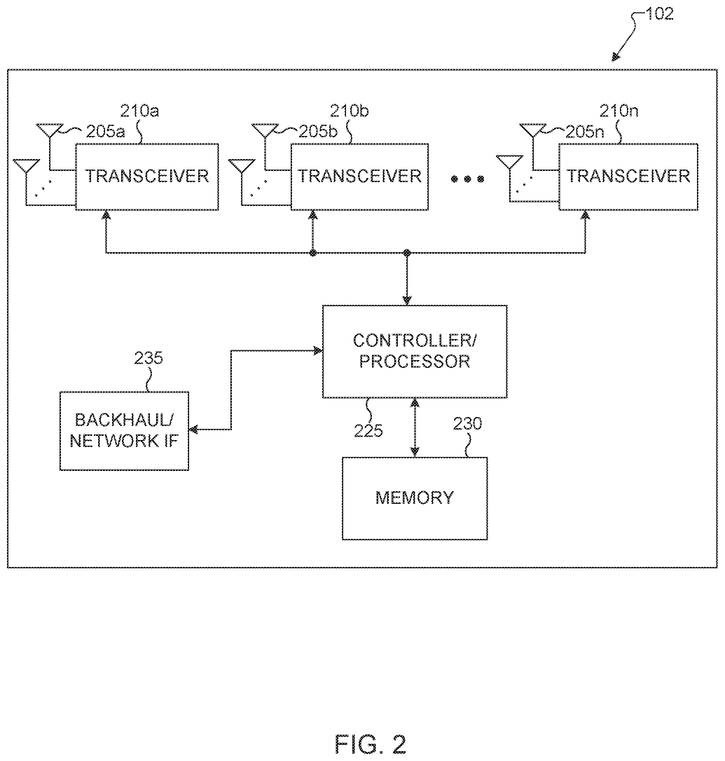

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support radio link monitoring in FD systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs. In embodiments of this disclosure, the gNB 102 may communicate an RLM-RS group to a UE (e.g., UE 116), and receive an indication of in-syn or out-of-sync from a UE (e.g., UE 116), via, e.g., any one of the antennas 205a-205n.

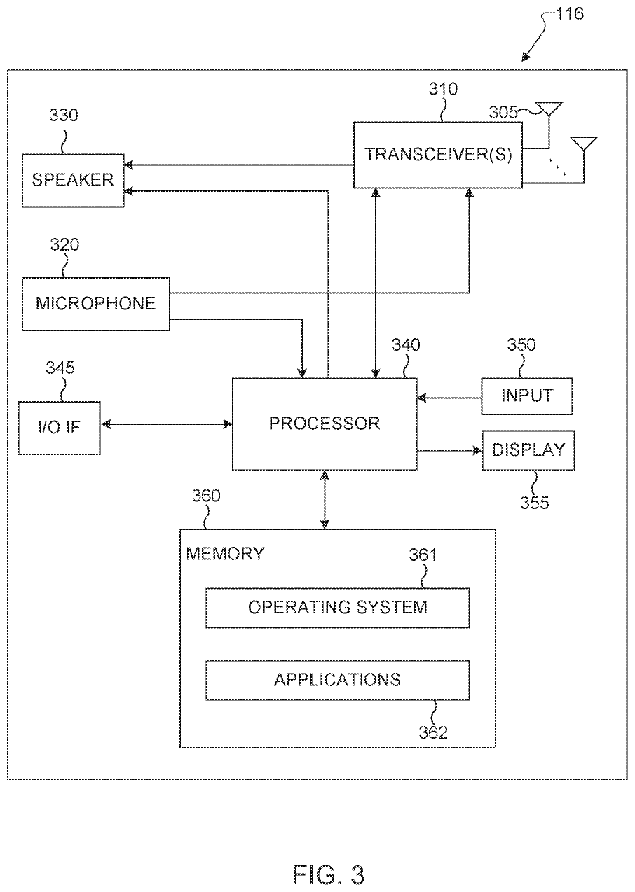

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data). In embodiments of this disclosure, the UE 116 may receive an RLM-RS group from a gNB (e.g., UE 102), and transmit an indication of in-syn or out-of-sync to a gNB (e.g., gNB 102), via the antenna 305.

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, as discussed in greater detail below, the processor 340 may execute processes to perform radio link monitoring in FD systems. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

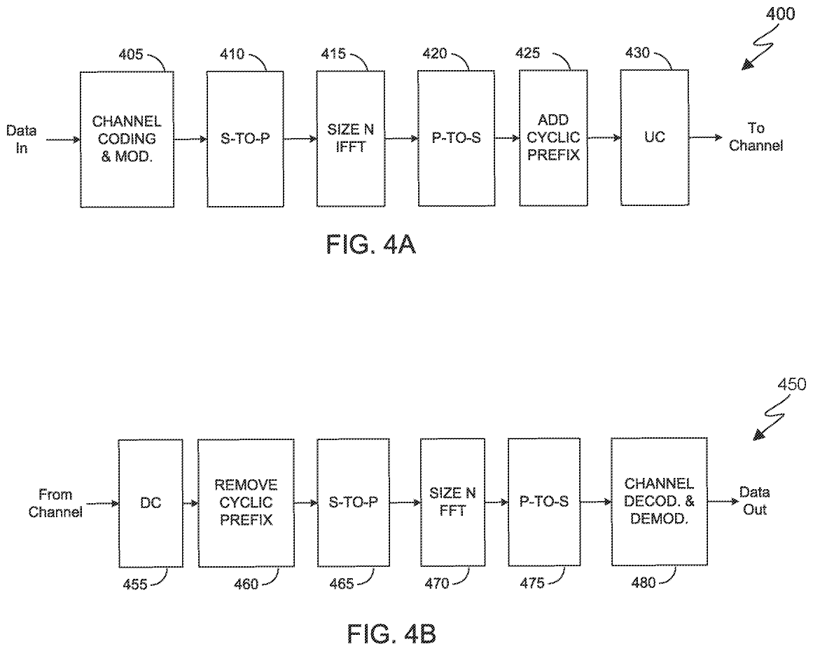

FIGS. 4A-B illustrate example wireless transmit and receive paths according to this disclosure. In the following description, a transmit path 400 of FIG. 4A, may be described as being implemented in an gNB (such as the gNB 102), while a receive path 450 of FIG. 4B, may be described as being implemented in a UE (such as a UE 116). However, it may be understood that the receive path 450 can be implemented in a BS and that the transmit path 400 can be implemented in a UE. In some embodiments, the receive path 450 is configured to perform radio link monitoring in FD systems as described in embodiments of the present disclosure.

The transmit path 400 as illustrated in FIG. 4A includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 450 as illustrated in FIG. 4B includes a down-converter (DC) 455, a remove cyclic prefix block 460, a serial-to-parallel (S-to-P) block 465, a size N fast Fourier transform (FFT) block 470, a parallel-to-serial (P-to-S) block 475, and a channel decoding and demodulation block 480.

As illustrated in FIG. 4A, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at a UE (e.g., 116) after passing through the wireless channel, and reverse operations to those at the gNB 102 are performed at the UE (e.g., 116).

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 as illustrated in FIG. 4A that is analogous to transmitting in the downlink to UEs 111-116 and may implement a receive path 500 as illustrated in FIG. 4B that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4A and FIG. 4B can be implemented using hardware or using a combination of hardware and software/firmware. As a particular example, at least some of the components in FIG. 4 and FIG. 4B may be implemented in software, while other components may be implemented by configurable hardware or a mixture of software and configurable hardware. For instance, the FFT block 470 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. FIGS. 4A-B may also be generally implemented using TDD UL-DL operations.

Although FIGS. 4A-B illustrate examples of wireless transmit and receive paths, various changes may be made to FIGS. 4A-B. For example, various components in FIG. 4A-B can be combined, further subdivided, or omitted and additional components can be added according to particular needs. Also, FIGS. 4A-B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. In embodiments of this disclosure, the gNB may transmit one or more RLM-RS groups to a UE.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may use spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ}) where Nₛₗₒₜ^{subframe,μ} is a number of slot per subframe for subcarrier spacing (SCS) configuration u.

In embodiments of this disclosure, the wireless transmit and receive paths may involve communications related to RLM-RS groups and in-sync of out-of-sync indications from a UE to a gNB as part of radio link monitoring in full duplex systems, as described in further detail below.

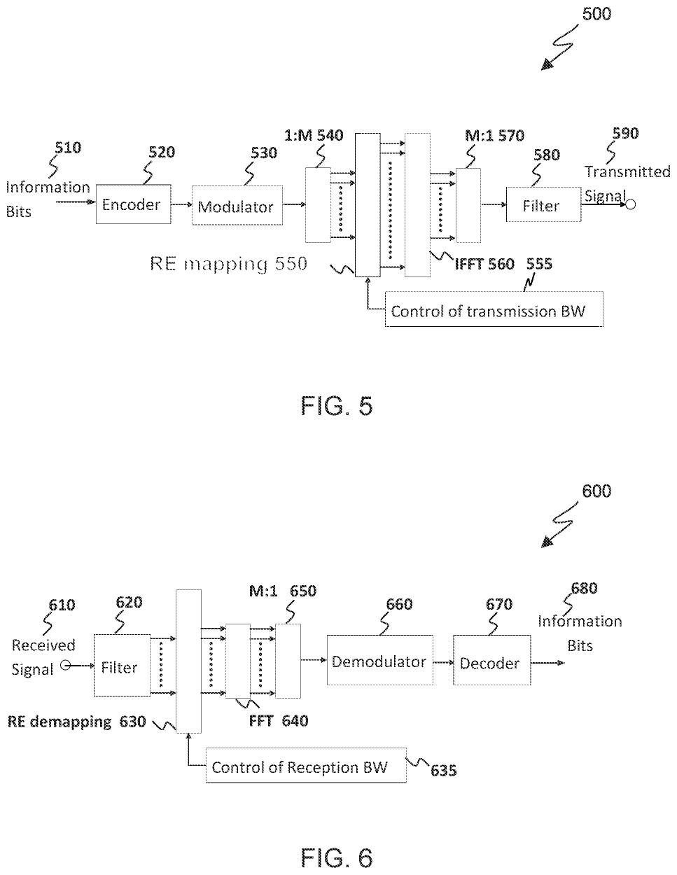

FIG. 5 illustrates a transmitter block diagram 500 for a PDSCH in a slot according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity. In embodiments of this disclosure, the transmitter block diagram 500 may be used to facilitate radio link monitoring in full duplex systems as discussed in further detail below.

FIG. 6 illustrates a receiver block diagram 600 for a PDSCH in a slot according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity. In embodiments of this disclosure, the receiver block diagram 600 may be used to facilitate radio link monitoring in full duplex systems as discussed in further detail below.

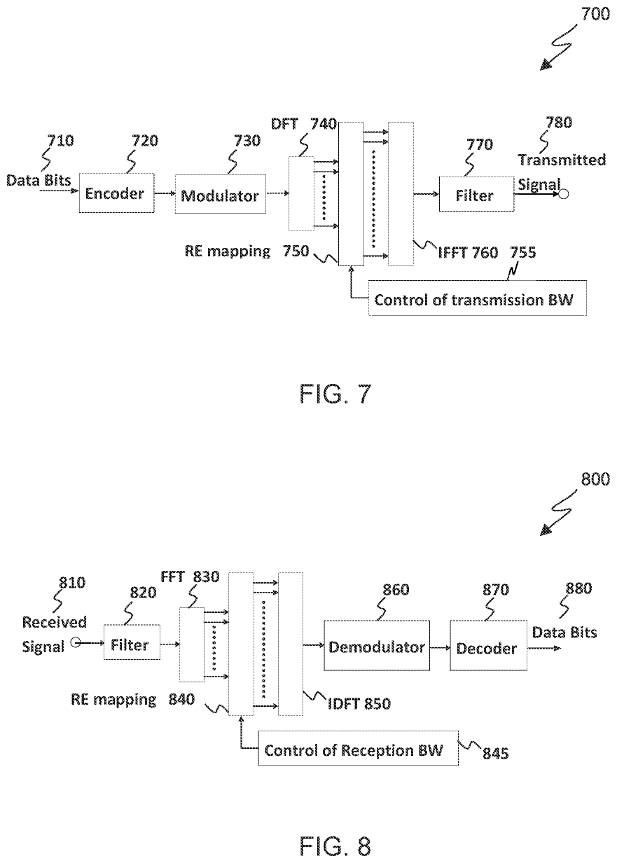

FIG. 7 illustrates a transmitter block diagram 700 for a PUSCH in a slot according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 855, unit 760 applies an IFFT and, after a cyclic prefix insertion (not shown), filtering is applied by filter 770 and a signal transmitted 780. In embodiments of this disclosure, the transmitter block diagram 700 may be used to facilitate radio link monitoring in full duplex systems as discussed in further detail below.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies an FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880. In embodiments of this disclosure, the receiver block diagram 800 may be used to facilitate radio link monitoring in full duplex systems as discussed in further detail below.

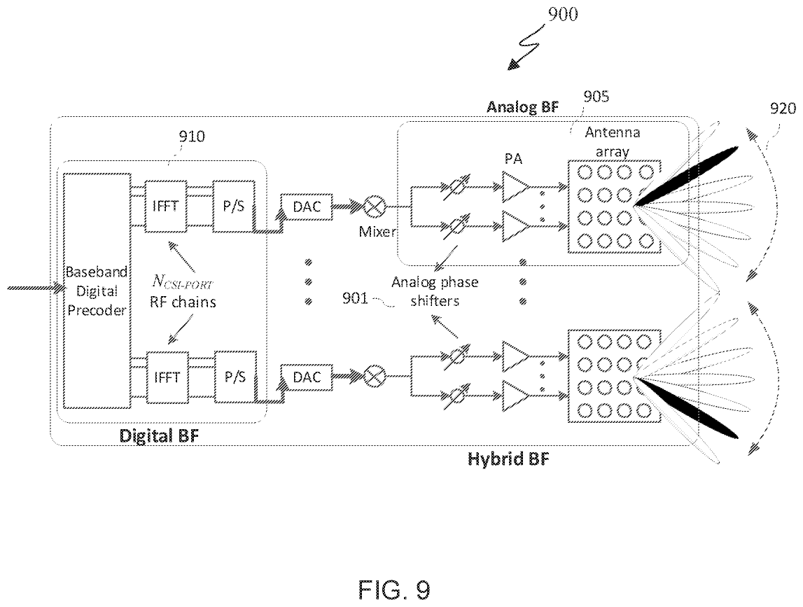

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

Rel-15 NR specifications support up to 32 CSI-RS antenna ports which enable a gNB to be equipped with a large number of antenna elements (such as 64 or 128). In this case, a plurality of antenna elements is mapped onto one CSI-RS port. For FR2, e.g., mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as FR2-2, e.g., >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) will be needed to compensate for the additional path loss. The antenna blocks or arrays 900 may be used to facilitate radio link monitoring in full duplex systems as discussed in further detail below.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “fullband”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

In embodiments of this disclosure, 5G NR radio supports time-division duplex (TDD) operation and frequency division duplex (FDD) operation. Use of FDD or TDD depends on the NR frequency band and per-country allocations. TDD is required in most bands above 2.5 GHz.

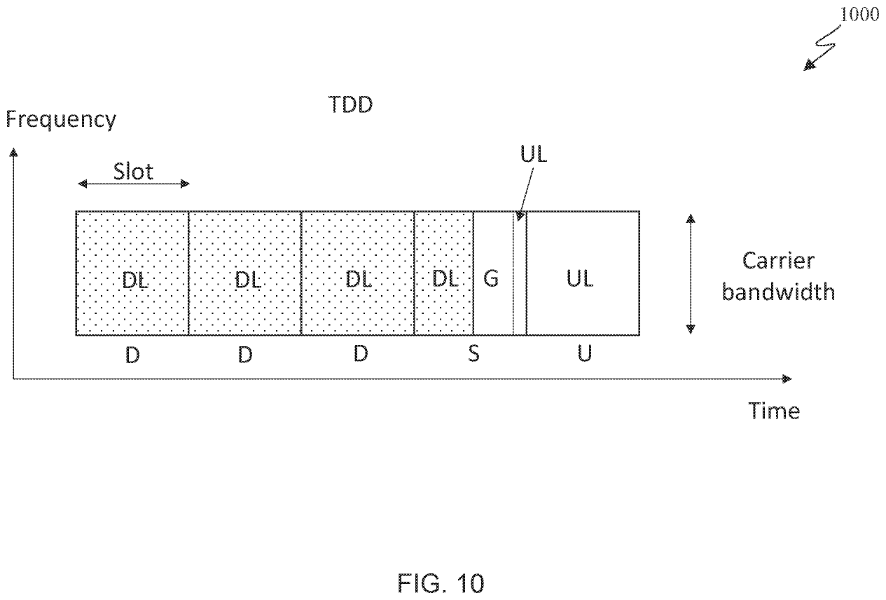

FIG. 10 illustrates an example diagram 1000 of structure of slots for a TDD communications system according to the embodiments of the disclosure. The diagram 1000 is for illustration only and other embodiments can be used without departing from the scope of the present disclosure.

A DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of CLI where, for example, DL receptions in a cell by a UE can experience large interference from UL transmissions in the same or neighboring cells from other UEs.

FD communications offer a potential for increased spectral efficiency, improved capacity, and reduced latency in wireless networks. When using FD communications, a gNB or a UE simultaneously receives and transmits on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, the term FD is used as a short form for a full-duplex operation in a wireless system. The terms Cross-Division-Duplex (XDD) and FD may be used interchangeably in the disclosure.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

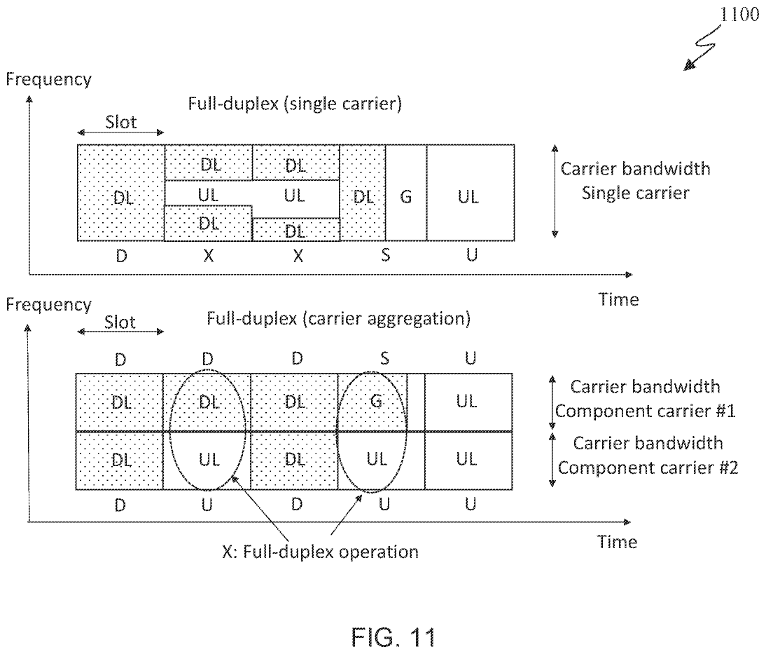

FIG. 11 illustrates two example FD configurations in a FD communications system 1100 according to embodiments of the disclosure. The embodiments of the FD configurations in a FD communications system 1100 is for illustration only. FIG. 11 does not limit the scope of this disclosure to any particular implementation of the FD communication system 1100 and other embodiments can be used without departing from the scope of the present disclosure.

For a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrate diagrams, various changes may be made to the diagrams 1000-1100 of FIGS. 10-11. For example, while certain diagrams (such as diagrams 1000, 1100) describe a certain slot structure, various components may be combined, further subdivided, or omitted or additional components can be added according to particular needs.

The DL radio link quality of the primary cell is monitored by a UE for the purpose of indicating out-of-sync/in-sync status to higher layers. The UE is not required to monitor the DL radio link quality in DL BWPs other than the active DL BWP. If a UE is configured with multiple DL BWPs for a serving cell, the UE performs RLM using RS(s) corresponding to resource indexes provided by RadioLinkMonitoringRS for the active DL BWP or, if RadioLinkMonitoringRS is not provided for the active DL BWP, using RS(s) provided for the active TCI state for PDCCH receptions in CORESETs on the active DL BWP.

A UE can be provided, for each DL BWP of a SpCell, a set of resource indexes, through a corresponding set of RadioLinkMonitoringRS, for radio link monitoring by parameter failure DetectionResources as defined in REF6. The UE is provided either a CSI-RS resource index, by parameter csi-RS-Index, or a SS/PBCH block index, by parameter ssb-Index.

For a CSI-RS resource, parameter powerControlOffsetSS is not applicable and a UE expects to be provided only ‘noCDM’ from cdm-Type, only ‘one’ and ‘three’ from density, and only ‘1 port’ from nrofPorts as described by REF4.

The UE can be provided up to N_{LR-RLM} RadioLinkMonitoringRS for link recovery procedures and for radio link monitoring. From the N_{LR-RLM} RadioLinkMonitoringRS, up to N_{RLM} RadioLinkMonitoringRS can be used for radio link monitoring depending on L_{MAX} as described in REF3, and up to two RadioLinkMonitoringRS can be used for link recovery procedures. For example, for the NR band n78 the parameters L_{MAX}=8, N_{LR-RLM}=6 and N_{RLM}=4 may be applied.

The UE monitors up to N_{RLM} RLM-RS resources in each corresponding carrier frequency range, depending on a maximum number of candidate SSBs per half frame according to REF3. When RLM-RS are not configured and no TCI state for PDCCH is activated, no RLM requirements are applicable.

If the UE is not provided RadioLinkMonitoringRS and the UE is provided for PDCCH receptions TCI states that include one or more CSI-RS, the UE uses for radio link monitoring the RS provided for the active TCI state for PDCCH reception if the active TCI state for PDCCH reception includes only one RS; if the active TCI state for PDCCH reception includes two RS, the UE expects that one RS is configured with qcl-Type set to ‘typeD’ and the UE uses the RS configured with qcl-Type set to ‘typeD’ for radio link monitoring; the UE does not expect both RS to be configured with qcl-Type set to ‘typeD’. The UE is not required to use for radio link monitoring an aperiodic or semi-persistent RS. For L_{MAX}=4, the UE selects the N_{RLM} RS provided for active TCI states for PDCCH receptions in CORESETs associated with the search space sets in an order from the shortest PDCCH monitoring periodicity. If more than one CORESETs are associated with search space sets having same PDCCH monitoring periodicity, the UE determines the order of the CORESET from the highest CORESET index as described in REF3.

A UE does not expect to use more than N_{RLM} RadioLinkMonitoringRS for radio link monitoring when the UE is not provided RadioLinkMonitoringRS.

In non-DRX mode operation, the physical layer in the UE assesses once per indication period the radio link quality, evaluated over the previous time period as defined in REF8 against thresholds (Qₒᵤₜ and Qᵢₙ) configured by rlmInSyncOutOfSyncThreshold. The UE determines the indication period as the maximum between the shortest periodicity for radio link monitoring resources and 10 msec. In DRX mode operation, the UE determines the indication period as the maximum between the shortest periodicity for radio link monitoring resources and the DRX period.

On each RLM-RS resource, the UE estimates the DL radio link quality and compares it to the thresholds Qₒᵤₜ and Qᵢₙ for the purpose of monitoring DL radio link quality of the cell. The threshold Qₒᵤₜ is defined as the level at which the DL radio link cannot be reliably received and corresponds to the out-of-sync block error rate (BLERₒᵤₜ) as defined in REF8. For SSB based and for CSI-RS based radio link monitoring, Q_{out_SSB} and Q_{out_CSI-RS}, respectively, are derived based on the hypothetical PDCCH transmission parameters defined in REF8. The threshold Qᵢₙ is defined as the level at which the DL radio link quality can be received with higher reliability than at Qₒᵤₜ and shall correspond to the in-sync block error rate (BLERᵢₙ) as defined in REF8. For SSB based and CSI-RS based radio link monitoring, Q_{in_SSB} and Q_{in_CSI-RS}, respectively, are defined in REF8. The UE evaluates whether the DL radio link quality on the configured RLM-RS resource estimated over the last T_{Evaluate_out_SSB} [msec] period becomes worse than the threshold Q_{out_SSB} within T_{Evaluate_out_SSB} [msec] evaluation period. The UE evaluates whether the DL radio link quality on the configured RLM-RS resource estimated over the last T_{Evaluate_in_SSB} [msec] period becomes better than the threshold Q_{in_SSB} within T_{Evaluate_in_SSB} [msec] evaluation period as defined in REF8. Similar principles apply to CSI-RS based radio link monitoring. Note that evaluation periods may be adjusted based on considerations such as measurement gaps and SMTC occasions as described in REF8.

The out-of-sync block error rate (BLERₒᵤₜ) and in-sync block error rate (BLERᵢₙ) are determined from the network configuration via parameter rlmInSyncOutOfSyncThreshold indicated by higher layers. When a UE is not provided rlmInSyncOutOfSyncThreshold from the network, the UE determines out-of-sync and in-sync block error rates from Configuration #0 in REF8 as default.

Further, with reference to details of the radio link monitoring procedure as described in REF8, a UE evaluates the out-of-sync and in-sync block error rates (BLER), BLERₒᵤₜ=10% and BLERᵢₙ=2%, respectively, according to BLER Configuration #0. For example, for SSB-based radio link monitoring and out-of-sync evaluation to derive Q_{out_SSB}, the UE assumes a set of hypothetical PDCCH transmission parameters, i.e., DCI format 1_0, 2 CORESET symbols, AL=8, CORESET=24 PRBs, REG bundle size=6, PDCCH-to-SSS energy ratio=4 dB, PDCCH DMRS-to-SSS energy ratio=4 dB as tabulated in REF8. For SSB-based radio link monitoring and in-sync evaluation to derive Q_{in_SSB}, the UE assumes a different set of hypothetical PDCCH transmission parameters, i.e., DCI format 1_0, 2 CORESET symbols, AL=4, CORESET=24 PRBs, REG bundle size=6, PDCCH-to-SSS energy ratio=0 dB, PDCCH DMRS-to-SSS energy ratio=0 dB as tabulated in REF8. Note that these hypothetical PDCCH transmission parameters intend to represent the most challenging link conditions for the UE before the UE indicates RLF, e.g., when reliable reception of even a small payload size of a scheduling DCI format is not meaningfully reliable. Similar considerations apply to CSI-RS based radio link monitoring and thresholds Q_{out_CSI-RS} and Q_{in_CSI-RS}.

The physical layer in the UE indicates, in frames where the radio link quality is assessed, out-of-sync to higher layers when the radio link quality is worse than the threshold Qₒᵤₜ for all resources in the set of resources for radio link monitoring. When the radio link quality is better than the threshold Qᵢₙ for any resource in the set of resources for radio link monitoring, the physical layer in the UE indicates, in frames where the radio link quality is assessed, in-sync to higher layers.

Upon detection of a number (RRC counter N310) of consecutive “out-of-sync” indications and expiry of RRC timer T310, the UE considers radio link failure to be detected and attempts RRC connection re-establishment for a number of times. If a number of random-access attempts by the UE fails, e.g., RRC connection re-establishment fails, the UE then reverts back to RRC_IDLE mode.

When considering Radio Link Monitoring in a full-duplex wireless communication system, this disclosure recognizes that several limitations and drawbacks need to be overcome. This disclosure provides solutions for the recognized limitations and drawbacks as discussed in detail below in various embodiments.

For example, this disclosure recognizes that UE evaluation of DL radio link quality using the configured RLM-RS resources on a non-full-duplex slot or symbol may not be representative of the DL radio link quality evaluated using RLM-RS resources on a full-duplex slot or symbol by the UE. In the following, for brevity, full-duplex slots/symbols and SBFD slots/symbols may be jointly referred to as SBFD slots/symbol and non-full-duplex slots/symbols and normal DL/UL slot/symbols may be jointly referred to as non-SBFD slots/symbols. When using an RLM-RS resource configured in a non-SBFD slot or symbol or multiple RLM-RS resources configured in both non-SBFD and SBFD slots or symbols, an ability of the UE to reliably receive PDCCH in an SBFD slot or symbol may be lost earlier than out-of-sync indications allow to detect. One consequence is loss of DL throughput due to the interruption and delay incurred by the gNB-side DL scheduling. For example, when using RLM-RS resources configured in a SBFD slot or symbol, an out-of-sync may be indicated earlier than when evaluating RLM-RS resources in a normal DL slot where the UE experiences better Rx SINR conditions. When using only RLM-RS resources configured in SBFD slots or symbols, one consequence can be a premature indication of RLF by the UE which results in an attempted RRC connection re-establishment procedure by the UE during which no data transmission/reception from/to the UE is possible at all, such as loss of data connectivity.

It also needs to be considered that for transmissions by a gNB in a full-duplex system, a different number of transmitter/receiver antennas, a different effective transmitter antenna aperture area, and/or different transmitter antenna directivity settings may be available for gNB transmissions in a DL slot or symbol, i.e., non-SBFD slot or symbol, when compared to gNB transmissions in a SBFD slot or symbol. Similar considerations may apply to gNB receptions in a normal UL slot or symbol when compared to gNB receptions in the UL sub-band of a SBFD slot. The EPRE settings of DL transmissions in a SBFD slot or symbol with full-duplex operation may be constrained to prevent gNB-side receiver AGC blocking and to enable effective implementation of serial interference cancellation (SIC) during receptions in the UL subband of the SBFD slot or symbol when comparted to the EPRE settings of DL transmissions in the normal DL slot. Therefore, the gNB transmission power budget and, correspondingly, the received signal strength available for the UE receiver, may not be same for a signal/channel being transmitted by the gNB on a non-SBFD slot/symbol when compared to transmission by the gNB of a same signal/channel on an SBFD slot/symbol. Similar observations hold when full-duplex transmission and reception by a gNB antenna based on multiple antenna panels is implemented. Then, QCL and transmit timing aspects may vary between different panels, and transmissions or receptions from/by the gNB may be subjected to different link gains depending on the antenna panel used for a transmission or reception instance.

Furthermore, it needs to be recognized that interference levels experienced by the UE receiver may differ between DL receptions in a normal DL slot or symbol and DL receptions in a SBFD slot or symbol. During receptions in a normal DL slot, the UE receiver may be interfered by co-channel DL transmissions from neighbor gNBs. During receptions in an SBFD slot or symbol, the UE receiver may be subjected to UE-to-UE inter-subband co-channel and/or UE-to-UE adjacent channel cross-link interference (CLI) stemming from UL-to-DL transmissions in the SBFD slot or symbol. Therefore, the resulting interference power levels and their variation experienced by the UE receiver may not be same for reception of signal/channels on non-SBFD slot/symbol when compared to reception of a signal/channel on an SBFD slot/symbol.

Using existing technology, a UE evaluates the out-of-sync and in-sync block error rates (BLER), BLERₒᵤₜ=10% and BLERᵢₙ=2%, respectively, for RLM according to BLER Configuration #0 as described in REF8. For example, for SSB-based radio link monitoring and out-of-sync evaluation to derive Q_{out_SSB}, the UE assumes a set of hypothetical PDCCH transmission parameters, i.e., DCI format 1_0, 2 CORESET symbols, AL=8, CORESET=24 PRBs, REG bundle size=6, PDCCH-to-SSS energy ratio=4 dB, PDCCH DMRS-to-SSS energy ratio=4 dB as tabulated in REF8. For SSB-based radio link monitoring and in-sync evaluation to derive Q_{in_SSB}, the UE assumes a different set of hypothetical PDCCH transmission parameters, i.e., DCI format 1_0, 2 CORESET symbols, AL=4, CORESET=24 PRBs, REG bundle size=6, PDCCH-to-SSS energy ratio=0 dB, PDCCH DMRS-to-SSS energy ratio=0 dB as tabulated in REF8. These hypothetical PDCCH transmission parameters represent the most challenging link conditions for the UE before the UE indicates RLF, e.g., when reliable reception of even a small payload size of a scheduling DCI format is not meaningfully reliable. Similar considerations apply to CSI-RS based radio link monitoring and thresholds Q_{out_CSI-RS} and Q_{in_CSI-RS}.

Upon detection of a number (RRC counter N310) of consecutive “out-of-sync” indications and expiry of RRC timer T310, the UE considers radio link failure to be detected and attempts RRC connection re-establishment for a number of times. It is noted that no data transmission/reception from/to the UE is then possible. If a number of random-access attempts by the UE fails, e.g., RRC connection re-establishment fails, the UE reverts back to RRC_IDLE mode.

For example, using existing technology, the UE evaluation of DL radio link quality can be configured using an RLM-RS resource, e.g., SSB, in a non-SBFD slot or symbol. The ability of the UE to reliably receive PDCCH in an SBFD slot or symbol may then be lost earlier than out-of-sync indications using the configured RLM-RS resources in the non-SBFD slot or symbols allow to detect. This is because the normal DL slots may benefit from higher DL Tx power and more favorable Tx antenna gains which result in more favorable Rx SINR conditions for the configured RLM-RS.

For example, using existing technology, the UE evaluation of DL radio link quality can be configured using an RLM-RS resource, e.g., 1-port CSI-RS with density=‘1’ or ‘3’, configured in a SBFD slot of symbol. Due to less DL Tx power and less favorable resulting Rx SINR conditions in a SBFD slot or symbol when compared to DL receptions of a same DL signal in a normal DL slot or symbol, out-of-sync may then be indicated earlier than when evaluating the Rx SINR conditions in a normal DL slot. Using an RLM-RS resource in an SBFD slot or symbol, the UE may indicate RLF failure and attempt RRC connection re-establishment earlier than necessary.

For example, using existing technology, multiple RLM-RS resources can be configured for a UE to evaluate radio link quality, e.g., using both SBFD and non-SBFD or normal DL slots or symbols. The UE physical layer then indicates, in frames where the radio link quality is assessed, out-of-sync to higher layers only when the radio link quality is evaluated worse than the threshold Qₒᵤₜ for all resources in the set of configured RLM-RS resources. However, out-of-sync for DL receptions of configured RLM-RS resources in a SBFD slot or symbol may occur at a different time, such as for example earlier than out-of-sync for DL receptions of configured RLM-RS resources in a normal DL slot due to less favorable Rx SINR conditions in the former. The ability of the UE to reliably receive PDCCH in an SBFD slot or symbol may then be lost already while in-sync indications by at least one resource in the set of configured RLM-RS resources, e.g., an RLM-RS resource configured in a normal DL slot or symbol.

For example, using existing technology, similar shortcomings as elaborated for the case of out-of-sync indications apply to the case of in-sync indications using multiple RLM-RS resources configured on both SBFD and non-SBFD or normal DL slots or symbols. This is because the UE physical layer indicates, in frames where the radio link quality is assessed, in-sync to higher layers when the radio link quality is better than the threshold Qᵢₙ for any resource in the set of RLM-RS resources.

One consequence is loss of DL throughput due to the interruption and delay incurred by the gNB-side DL scheduling. For example, when using RLM-RS resources configured in a SBFD slot or symbol, an out-of-sync may be indicated earlier than when evaluating RLM-RS resources in a normal DL slot where the UE experiences better Rx SINR conditions. When using only RLM-RS resources configured in SBFD slots or symbols, one consequence can be a premature indication of RLF by the UE which results in an attempted RRC connection re-establishment procedure by the UE during which no data transmission/reception from/to the UE is possible at all, such as loss of data connectivity.

This disclosure provides methods and solutions in a full-duplex system to allow for continued transmissions and receptions from/to a UE when operating in presence of differing Rx SINR conditions that the UE may experience in non-SBFD and SBFD slots or symbols.

Additionally, this disclosure recognizes that evaluation of DL radio link quality using the configured RLM-RS resources only on a SBFD slot or symbol may result in undue operational constraints or may not be possible at all when gNB-side SBFD operation is enabled on legacy TDD flexible symbols or slots. That is undesirable because either gNB scheduling of UL transmission from the UE using the SBFD UL subband may be restricted in time-domain resulting in a loss of UL coverage for the UE, or resulting in a reduced UL throughput in the full-duplex system, or the ability to evaluate RLM is lost for a UE configured with an UL subband in the SBFD slot, or a UE may not be configurable to efficiently support gNB-side full-duplex operation by means of SRS transmissions for CLI estimation in such a slot. Additionally, a larger RS overhead would be required in order to also support RLM for UEs that do not support full-duplex operation. Similar considerations apply in case that evaluation of DL radio link quality using configured RLM-RS resources is restricted to be only on a DL slot or symbol. Further, an evaluation for RLM only in DL slots or symbols, or only in SBFD slots or symbols, may not reflect the link quality is SBFD slots or symbols, or in DL slots or symbols, respectively.

This disclosure recognizes that UE evaluation of DL radio link quality using configured RLM-RS resources on a serving cell with full-duplex operation when legacy UEs are communicating on the serving cell may result in operational constraints or may not be possible.

It needs to be considered that for a set of symbols of a slot that are indicated to a legacy UE as flexible (F symbols) by tdd-UL-DL-ConfigurationCommon, and tdd-UL-DL-ConfigurationDedicated if provided, a legacy UE does not expect to receive both dedicated higher layer parameters configuring transmission from the UE in the set of symbols of the slot and dedicated higher layer parameters configuring reception by the UE in the set of symbols of the slot. For operation on a single carrier in unpaired spectrum, if a legacy UE is configured by higher layers to receive a PDCCH, or a PDSCH, or a CSI-RS in a set of symbols of a slot, the UE receives the PDCCH, the PDSCH, or the CSI-RS if the UE does not detect a DCI format 0_0/0_1/1_0/1_1, or 2_3 that indicates to the UE to transmit a PUSCH, a PUCCH, a PRACH, or a SRS in at least one symbol of the set of symbols of the slot; otherwise, the UE does not receive the PDCCH, or the PDSCH, or the CSI-RS in the set of symbols of the slot.

For example, using existing technology, CSI-RS based radio link monitoring may be configured for the UE on a symbol in a flexible (F) slot but then no UL transmission in all other symbols of the flexible slot using the SBFD UL subband is possible for the UE. Supporting CSI-RS based radio link monitoring in a flexible slot may reduce the achievable UL throughput because the SBFD UL subband may not be scheduled for the UE in the flexible slot. Simultaneous higher layer configuration of reception of the CSI-RS for radio link monitoring by the UE and SRS transmission from the UE for UL channel sounding in a same slot is not supported. Simultaneous support by a UE for the RLM and CLI features in the SBFD slots then requires the use of multiple SBFD slots and the use of distinct and separate slots to configure the UE with the CSI-RS for RLM and the SRS for CLI, respectively. However, there are only few SBFD slots available in most practical and currently deployed legacy TDD UL-DL configurations, e.g., at most 3 using DXXXU.

Thus, the gNB scheduling of transmissions from the UE using an SBFD UL subband may need to be restricted in time-domain when legacy UEs are present on the serving cell that supports full-duplex. That restriction may result in several undue operational restrictions such as a reduced UL coverage for an SBFD-aware UE, a reduced UL throughput for a UE or a serving cell, or a loss of an ability to evaluate RLM when an SBFD-aware UE is configured with an UL subband in an SBFD slot. Additionally, a larger signaling overhead would be required to configure RLM-RS for RLF evaluations by legacy and by SBFD-aware UEs.

This disclosure provides methods and solutions in a full-duplex system to allow evaluation of DL radio link quality by a UE when an SBFD subband is configured for the UE in a slot or symbol. The disclosure addresses the above shortcomings and provides additional design aspects for supporting radio link monitoring in full-duplex systems, and provides solutions as fully elaborated in the following. In embodiments, a UE evaluates In-sync/Out-of-Sync for SBFD slot using RLM-RS in non-SBFD slot plus an adjustment factor. The adjustment factor may be an offset/scaling value, separate assumed target BLER settings or PDCCH parameters. In more embodiments, a UE performs RLM evaluations using separate settings and configurations for the SBFD/non-SBFD slots. In further embodiments, UE is indicated/determines RLM-RS subset to evaluate RLM-RS distinctly for SBFD/non-SBFD slot. In some embodiments, a UE signals secondary radio link failure or re-establishment notification(s) to higher layers or gNB for RLM-RS subset not resulting in UE radio link failure. In embodiments, the disclosure considers methods where an RLM-RS resource on a SBFD slot or symbol and an indicated/determined adjustment factor or an indicated/determined adjustment condition are used for radio link quality evaluation on the SBFD slot or symbol. An adjustment factor can be an offset or scaling value with reference to a RS resource or RS resource index. An RS resource or RS resource index on the SBFD slot or symbol can be PDCCH-based such as using PDCCH DMRS or can be CSI report based such as using a NZP CSI-RS resource for the UE to evaluate radio link quality. The disclosure considers methods where a UE initiates a fallback procedure when insufficient radio link conditions are detected on a subset of slots on the serving cell. A UE may be provided a fallback signaling indication by the gNB. A fallback procedure may be associated with a restricted or limited set of time-domain resources in a full-duplex system.

In one embodiment, a UE evaluates in-sync or out-of-sync for full-duplex/SBFD slots or symbols using an RLM-RS associated with a RS resource or RS resource index configured in the UE in a non-full-duplex/non-SBFD slot or symbol and using an indicated/determined adjustment factor. The adjustment factor may correspond to an offset or a scaling value to a measurement that the UE obtains based on the RLM-RS in a normal (non-SBFD) DL slot or symbol. The adjustment factor may correspond to an out-of-sync or an in-sync block error rate or to a corresponding parameter rlmInSyncOutOfSyncThreshold associated with full-duplex/SBFD slots or symbols. The adjustment factor may correspond to hypothetical PDCCH transmission parameter(s) associated with full-duplex/SBFD slots or symbols.

In one example, a UE is provided an RLM-RS resource in a non-SBFD slot or symbol. The UE is indicated or determines an adjustment factor as an offset, or a scaling value, Delta_{OOS} to evaluate out-of-sync on an SBFD slot or symbol based on a measurement using the RLM-RS. For example, the UE is indicated or determines an adjustment factor as an offset, or a scaling value, Delta_{IS} for scaling the measurement using the RLM-RS to evaluate in-sync on an SBFD slot or symbol. The UE determines the Qₒᵤₜ or Qᵢₙ threshold(s) for an SBFD slot or symbol after scaling a respective SSB or CSI-RS reception power of the RLM-RS resource in a non-SBFD slot or symbol with the adjustment factor. For example, the UE adjusts the SSB or CSI-RS reception power of an RLM-RS in a non-SBFD slot or symbol by Delta_{OOS} to determine an adjusted reception power to evaluate the out-of-sync criterion for an SBFD slot or symbol. For example, the UE adjusts the SSB or CSI-RS reception power of an RLM-RS in a non-SBFD slot or symbol by Delta_{IS} to determine an adjusted reception power to evaluate the in-sync criterion for an SBFD slot or symbol. The UE then uses an adjusted reception power and compares it to the thresholds Qₒᵤₜ and Qᵢₙ for the purpose of monitoring DL radio link quality for SBFD slots or symbols in a serving cell. The physical layer in the UE determines out-of-sync for an SBFD slot or symbol when the radio link quality is worse than the threshold Qₒᵤₜ. When the radio link quality is better than the threshold Qᵢₙ, the physical layer in the UE determines in-sync for an SBFD slot or symbol.

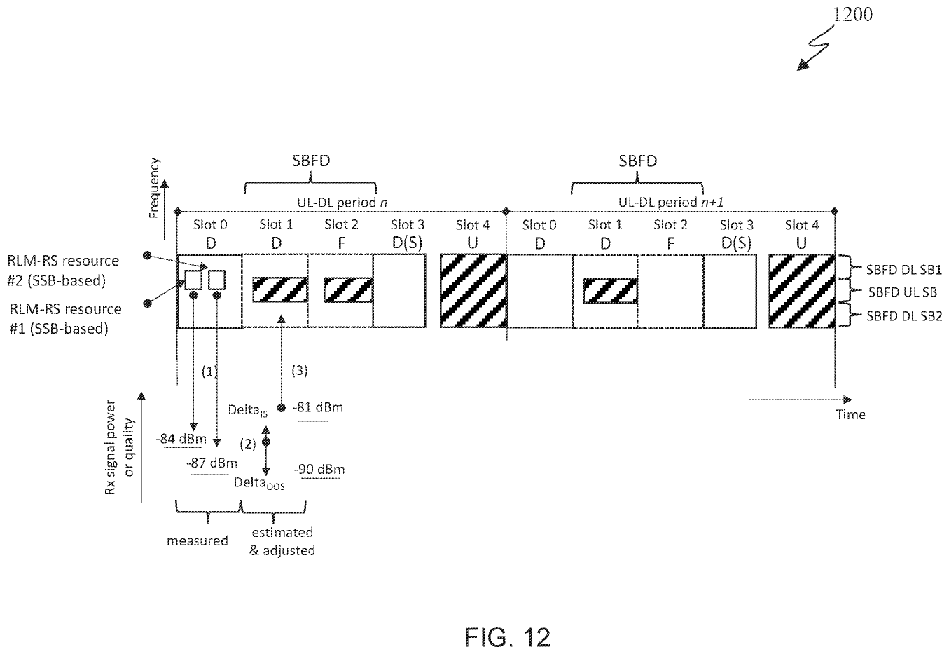

FIG. 12 illustrates an example diagram of a FD communication system 1200 using an offset or scaling value as adjustment factor for radio link monitoring of SBFD slots or symbols. The embodiment of a FD system 1200 using an offset or scaling value as adjustment factor for radio link monitoring of SBFD slots or symbols illustrated in FIG. 12 is for illustration only. FIG. 12 does not limit the scope of this disclosure to any particular implementation of a FD communication system 1200.

In another example, a UE is provided an RLM-RS resource in a non-SBFD slot or symbol. The UE is indicated or determines an adjustment factor as out-of-sync or in-sync block error rate (or a corresponding parameter rlmInSyncOutOfSyncThreshold) to evaluate out-of-sync and in-sync for an SBFD slot or symbol. For example, the UE is indicated or determines an adjustment factor as an out-of-sync block error rate (BLERₒᵤₜ) and an in-sync block error rate (BLERᵢₙ) for an SBFD slot or symbol. The UE determines the Qₒᵤₜ or Qᵢₙ threshold(s) for an SBFD slot or symbol using a respective SSB or CSI-RS reception power of the RLM-RS resource in a non-SBFD slot or symbol and using the out-of-sync block error rate (BLERₒᵤₜ) and an in-sync block error rate (BLERᵢₙ) for SBFD slots or symbols. For example, the UE uses the SSB or CSI-RS reception power of an RLM-RS in a non-SBFD slot or symbol to evaluate the out-of-sync criterion for an SBFD slot or symbol based on BLERₒᵤₜ for the SBFD slot or symbol. For example, the UE uses the SSB or CSI-RS reception power of an RLM-RS in a non-SBFD slot or symbol to evaluate the in-sync criterion for an SBFD slot or symbol based on BLERᵢₙ for the SBFD slot or symbol. The physical layer in the UE determines out-of-sync for an SBFD slot or symbol when the radio link quality is worse than the threshold Qₒᵤₜ. When the radio link quality is better than the threshold Qᵢₙ, the physical layer in the UE determines in-sync for an SBFD slot or symbol.

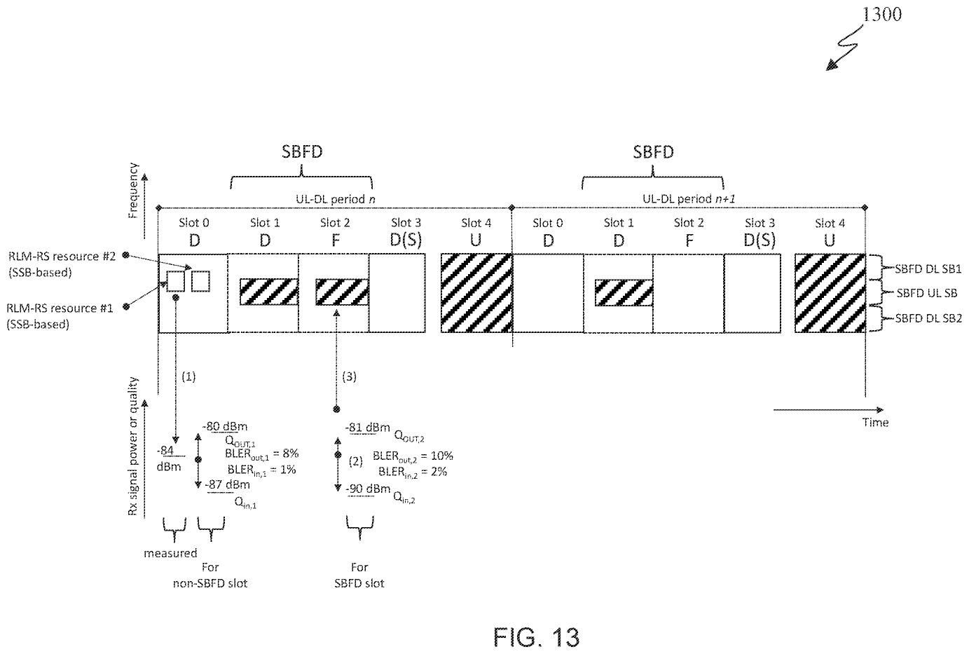

FIG. 13 illustrates an example diagram of a full-duplex communication system 1300 using out-of-sync and in-sync block error rate(s) as at least one adjustment factor for radio link monitoring of SBFD slots or symbols. The embodiment of a FD system 1300 using out-of-sync and in-sync block error rate(s) as an adjustment factor for radio link monitoring of SBFD slots or symbols illustrated in FIG. 13 is for illustration only. FIG. 13 does not limit the scope of this disclosure to any particular implementation of a FD communication system 1300.

In another example, the UE is configured with an RLM-RS resource in a non-SBFD slot or symbol. The UE is indicated or determines an adjustment factor as hypothetical PDCCH transmission parameters to evaluate out-of-sync and in-sync for an SBFD slot or symbol. For example, the UE is indicated or determines a set of hypothetical PDCCH transmission parameters, such as a CCE aggregation level or a ratio of PDCCH RE energy to average SSS RE energy, for an SBFD slot or symbol. The UE determines the Qₒᵤₜ or Qᵢₙ threshold(s) for an SBFD slot or symbol using a respective SSB or CSI-RS reception power of the RLM-RS resource in a non-SBFD slot or symbol and using the assumed PDCCH transmission parameters for an SBFD slot or symbol. The physical layer in the UE determines out-of-sync for an SBFD slot or symbol when the radio link quality is worse than the threshold Qₒᵤₜ. When the radio link quality is better than the threshold Qᵢₙ, the physical layer in the UE determines in-sync for an SBFD slot or symbol.

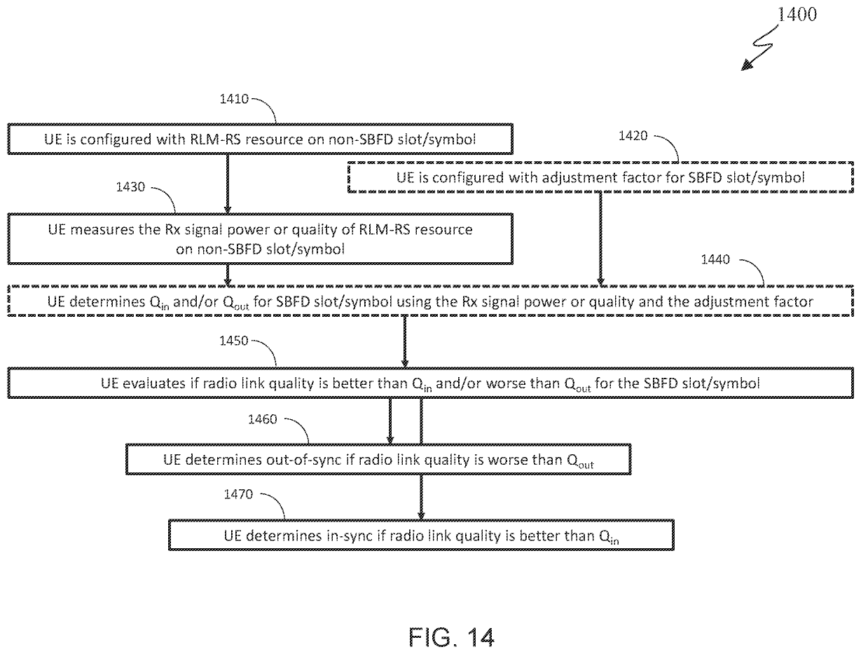

FIG. 14 illustrates an example process flowchart of a method 1400 of a full-duplex communication system using an adjustment factor for radio link monitoring of SBFD slots or symbols. The embodiment of the method 1400 of a FD communication system using out-of-sync and in-sync block error rate(s) as an adjustment factor for radio link monitoring of SBFD slots or symbols illustrated in FIG. 14 is for illustration only. FIG. 14 does not limit the scope of this disclosure to any particular implementation of the method 1400.

The method 1400 begins with the UE being configured with an RLM-RS resource on a non-SBFD slot/symbol, 1410. The UE is configured with an adjustment factor for SBFD slot or symbol, 1420. The UE measures the Rx signal power or quality of RLM-RS resource on a non-SBFD slot/symbol, 1430. The UE determines Qᵢₙ and/or Qₒᵤₜ for SBFD slot/symbol using the Rx signal power or quality and the adjustment factor, 1440. The UE evaluates if radio link quality is better than Qᵢₙ and/or worse than Qₒᵤₜ for the SBFD slot/symbol, 1450. The UE either determines out-of-sync if radio link quality is worse than Qₒᵤₜ. 1460, or determines in-sync if radio link quality is better than Qᵢₙ, 1470.

The UE evaluation of in-sync or out-of-sync for full-duplex/SBFD slots or symbols using an RS resource or RS resource index configured in the UE in a non-full-duplex/non-SBDF slot or symbol and using an indicated/determined adjustment factor may occur independently of the presence or absence of any RS resources or RS resource indices for radio link quality evaluation on SBFD slots or symbols. RLM-RS resources on SBFD slots or symbols may be configured or transmitted by the network or may not be present for a UE or for other UEs, a UE performs radio link monitoring using an RLM-RS resource on a non-SBFD slot or symbol and using the adjustment factor when indicated or configured.

One advantage of the embodiment is that radio link quality evaluation can be configured for the UE to account for a single assumed link degradation factor when comparing DL receptions in non-SBFD and SBFD slots. When the number of more available DL TRX for DL transmissions using a normal DL slot and the number of fewer DL TRX for DL transmissions using the DL subbands of an SBFD slot are known and other antenna panel design parameters are accounted for, the difference for radio link quality evaluation can be estimated by the network implementation and be provided as single offset or adjustment value to balance the expected RLM behavior for the non-SBFD and SBFD slots. UE complexity to implement radio link quality evaluation in a full-duplex system is not increased compared to conventional half-duplex TDD operation as a UE can rely only on RLM-RS measurements in normal DL slots in both cases.

In another embodiment, a UE evaluates in-sync or out-of-sync for full-duplex/SBFD slots or symbols using an adjustment or offset or scaling value with reference to an RS resource or RS resource index that can be indicated to the UE by higher layers for a normal DL slot or symbol.

The UE determines the Qₒᵤₜ or Qᵢₙ threshold(s) for a full-duplex or SBFD slot/symbol after scaling a respective SSB or CSI-RS reception power with an adjustment or offset or scaling value for an RLM-RS resource configured in a normal DL slot or symbol. Separate adjustment or offset or scaling value(s) may be provided to the UE for the Qₒᵤₜ or Qᵢₙ threshold(s). Multiple adjustment or offset or scaling value(s) may be provided to the UE for the Qₒᵤₜ and Qᵢₙ threshold(s), respectively. A specified default adjustment or offset or scaling value may be assumed by the UE when a corresponding indication is not provided to the UE by higher layers.

For example, a first RLM-RS resource may be configured on non-SFBD slots or symbols. A second RLM-RS resource may be configured on SFBD slots or symbols. The UE is provided with an adjustment value Delta_{OOS}=−6 dB by higher layers for the second RLM-RS resource for out-of-sync evaluation. The UE is provided with an adjustment value Delta_{IS}=+3 dB by higher layers for in-sync evaluation. The UE measures RSRP/RSRQ for an SSB-based RS of the first RLM-RS resource to evaluate if the out-of-sync criterion is met. The UE uses the RSRP/RSRQ measurement and applies the configured Delta_{OOS} adjustment value to determine if the out-of-sync criterion for the full-duplex/SBFD slot is met, e.g., the UE scales a respective SSB or CSI-RS reception power with an adjustment or offset or scaling value for an RLM-RS resource configured in a normal DL slot or symbol. The UE uses the RSRP/RSRQ measurement and applies the configured Deltas adjustment value to determine if the in-sync criterion for a full-duplex/SBFD slot is met.

In more embodiments of this disclosure, a first and a second RLM-RS resource in the set of reference signal (RS) resources or RS resource indices provided to the UE for radio link monitoring are associated with separate parameters rlmInSync OutOfSyncThreshold. A first and a second RLM-RS resource in the set of RS resources or RS resource indices provided to the UE for radio link monitoring can also be separately indicated or specified for corresponding out-of-sync and in-sync block error rates.

For example, a first RLM-RS resource may be configured on non-SFBD slots or symbols. A second RLM-RS resource may be configured on SFBD slots or symbols. The UE is indicated by higher layers a first out-of-sync block error rate (BLER_{out,1}) and a first in-sync block error rate (BLER_{in,1}) via parameter rlmInSyncOutOfSyncThreshold₁ for the first RLM-RS resource. The UE is indicated by higher layers a second out-of-sync block error rate (BLER_{out,2}) and a second in-sync block error rate (BLER_{in,2}) via parameter rlmInSyncOutOfSyncThreshold₂ for the second RLM-RS resource. When a UE is not provided rlmInSyncOutOfSyncThreshold₁ or rlmInSyncOutOfSyncThreshold₂ from the network, the UE may determine an out-of-sync or an in-sync block error rate from a default configuration. For example, the UE may evaluate the out-of-sync and in-sync block error rates BLER_{out,1}=8% and BLER_{in,1}=1%, BLER_{out,2}=10% and BLER_{in,2}=2%, respectively, for RLM in non-full-duplex slots and in full-duplex slots, respectively.

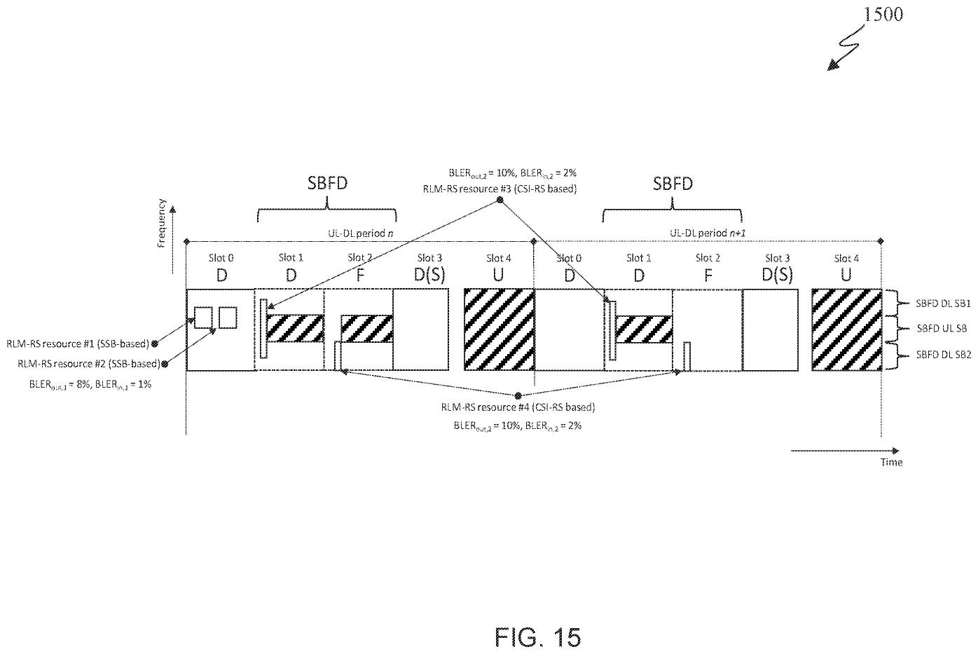

FIG. 15 illustrates an example diagram of a full-duplex communication system 1500 using two RLM-RS resources configured with separate out-of-sync and in-sync block error rates. The embodiment of a FD system 1500 using two RLM-RS resources configured with separate out-of-sync and in-sync block error rates illustrated in FIG. 15 is for illustration only. FIG. 15 does not limit the scope of this disclosure to any particular implementation of a FD communication system 1500.

In one embodiment, a first and a second RLM-RS resource in the set of RS resources or RS resource indices provided to the UE for radio link monitoring are associated with separate sets of hypothetical PDCCH transmission parameters. Parameters associated with a hypothetical PDCCH transmission may include a DCI format and/or a DCI format size, a number of CORESET symbols, a CCE aggregation level, an EPRE value or power ratio such as between PDCCH RE energy and SSS energy or between PDCCH DMRS energy and SSS RE energy, a CORESET bandwidth such as number of PRBs for the CORESET, an SCS, a DMRS precoder granularity, a REG bundle size, a CP length or REG-to-CCE mapping. Parameters associated with a hypothetical PDCCH transmission for a first RLM-RS resource and a second RLM-RS resource may be provided/determined separately for out-of-sync evaluation or may be provided/determined separately for in-sync evaluation. Some or all parameters associated with a hypothetical PDCCH transmission to evaluate out-of-sync and in-sync may be configured the same.

For example, a first RLM-RS resource may be configured on non-SFBD slots or symbols. A second RLM-RS resource may be configured on SFBD slots or symbols. The UE may be indicated, specified, or determine a first hypothetical PDCCH transmission parameter set for SSB-based radio link monitoring and out-of-sync evaluation to derive Q_{out_SSB} for the first RLM-RS resource in non-SBFD symbols, e.g., DCI format 1_0, 2 CORESET symbols, AL=8, CORESET=24 PRBs, REG bundle size=6, PDCCH-to-SSS energy ratio=4 dB, PDCCH DMRS-to-SSS energy ratio=4 dB. The UE may be indicated, specified, or determine a second hypothetical PDCCH transmission parameter set for CSI-RS based radio link monitoring and out-of-sync evaluation to derive Q_{out_CSI-RS} for the second RLM-RS resource in SBFD symbols, e.g., DCI format 1_0, 1 CORESET symbol, AL=4, CORESET=48 PRBs, REG bundle size=6, PDCCH-to-SSS energy ratio=0 dB, PDCCH DMRS-to-SSS energy ratio=0 dB. In this example and for simplicity, a same set of hypothetical PDCCH transmission parameters for radio link monitoring and in-sync evaluation may be assumed and configured for the first and the second RLM-RS resource.

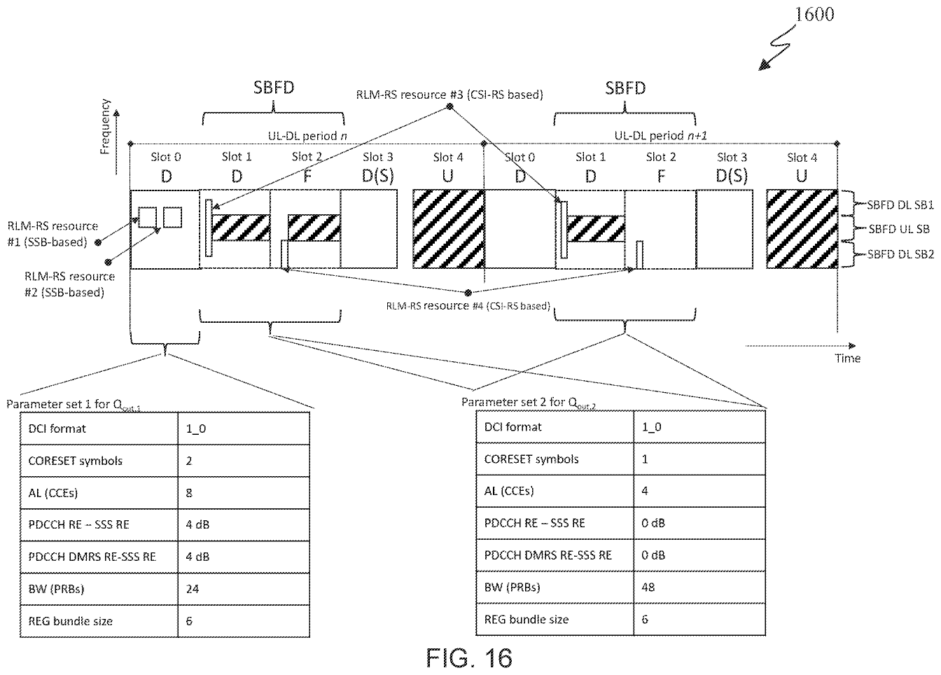

FIG. 16 illustrates an example diagram of a full-duplex communication system 1600 using two RLM-RS groups associated with separate parameter sets. The embodiment of a FD system 1600 using an offset or scaling value as adjustment factor for radio link monitoring of SBFD slots or symbols illustrated in FIG. 16 is for illustration only. FIG. 16 does not limit the scope of this disclosure to any particular implementation of a FD communication system 1600.

It is one advantage of the solution that the assumed or hypothetical PDCCH transmission parameter sets can be indicated, specified, or determined for a UE to adjust the radio link quality evaluation to the needs and specifics of the SBFD DL or UL subband configuration. The radio link quality can be indicated separately to higher layers for the set of non-full-duplex or normal DL slots or symbols and the set of SBFD slots or symbols. The UE can evaluate and indicate the radio link quality using typical or expected PDCCH configuration in the SBFD slots or symbols.

In one embodiment, a UE evaluates a first RLM-RS resource and a second RLM-RS resource in the set of RS resources or RS resource indices using separately determined/indicated respective evaluation periods T_{Evaluate_out} and/or T_{Evaluate_in}. Evaluation periods and adjustment factors applied to a first RLM-RS resource and a second RLM-RS resource may account for presence/absence of non-SBFD/SBFD slots. For example, an evaluation period for a first RLM-RS resource may be increased or scaled by accounting or adjusting for a number of SBFD slots or symbols during a time period. For example, an evaluation period for a second RLM-RS resource may be decreased or scaled by accounting or adjusting for a number of non-SBFD slots during a time period.

For example, a first RLM-RS resource may be configured on non-SFBD slots or symbols. A second RLM-RS resource may be configured on SFBD slots or symbols. The UE evaluates whether the DL radio link quality on the first RLM-RS resource estimated over the last T_{Evaluate_out,1} [msec] period becomes worse than the threshold Q_{out,1} within T_{Evaluate_out,1} [msec] evaluation period. The UE evaluates whether the DL radio link quality on the first RLM-RS resource estimated over the last T_{Evaluate_in,1} [msec] period becomes better than the threshold Q_{in,1} within T_{Evaluate_in,1} [msec] evaluation period. The UE evaluates whether the DL radio link quality on the second RLM-RS resource estimated over the last T_{Evaluate_out,2} [msec] period becomes worse than the threshold Q_{out,2} within T_{Evaluate_out,2} [msec] evaluation period. The UE evaluates whether the DL radio link quality on the second RLM-RS resource estimated over the last TE_{valuate_in,2} [msec] period becomes better than the threshold Q_{in,2} within T_{Evaluate_in,2} [ms] evaluation period. For example, in the case of no DRX, T_{Evaluate_out,1}=200 ms and T_{Evaluate_out,2}=300 ms, T_{Evaluate_in,1}=100 ms and T_{Evaluate_in,2}=150 ms.

Advantageously, the evaluation period for the SBFD slots or symbols can be selected and indicated/determined separately from the evaluation period for non-full-duplex slots. For example, the first RLM-RS resource configured for radio link quality evaluation, e.g., using SSB-based RLM in a legacy DL slot, may use legacy NR settings and parameters T_{Evaluate_out,1}=200 msec and T_{Evaluate_in,1}=100 msec. The second RLM-RS resource configured for radio link quality evaluation, e.g., using CSI-RS based RLM in SBFD slots may use larger indication latency settings to allow for more signal power and interference variations before out-of-sync is indicated by the UE in the SBFD resources.

In more embodiments of this disclosure, the UE is provided a subset of the set of RS resources or RS resource indices configured as RLM-RS resource(s) for radio link monitoring. For example, the UE is provided by higher layer signaling a subset of M RS resources or RS resource indices from the set of N_{LRM} RLM-RS resources for radio link monitoring or from the set of N_{LR-RLM} RLM-RS resources for radio link monitoring and link recovery. For example, the UE may be provided a list or sequence or bitmap representative of M RS resources or RS resource indices from the set of N_{LRM} or N_{LR-RLM} RLM-RS resources. A UE may determine a subset of M RS resources or RS resource indices from the set of N_{LRM} Or N_{LR-RLM} RLM-RS resources configured for radio link monitoring. For example, the UE may determine the first or the last M RS resources or RS resource indices from a set of N_{LRM} Or N_{LR-RLM} RLM-RS resources as a subset. For example, M may be 1 or M may be associated with default value(s). The indicated or determined subset of M RLM-RS resources, i.e., the RLM-RS subset, from the set of N_{LRM} or N_{LR-RLM} RLM-RS resources configured for radio link monitoring may be configured with separate parameter settings to evaluate the out-of-sync or in-sync criteria. The indicated or determined subset of M RLM-RS resources from the set of N_{LRM} or N_{LR-RLM} RLM-RS resources configured for radio link monitoring may be used by the UE to determine an out-of-sync or in-sync indication to higher layers or to the gNB, separately from an out-of-sync or in-sync indication determined for the set of N_{LRM} or N_{LR-RLM} RLM-RS resources. Multiple subsets of RLM-RS resources may be provided to the UE or determined by the UE.

A subset of the set of RS resources or RS resource indices configured for radio link quality evaluation may be indicated to the UE or may be determined by the UE. For example, the UE is provided a CSI-RS resource or CSI-RS resource index, or an SSB resource or SSB index, as RS resource or RS resource index for the RLM-RS subset. An RLM-RS subset may be associated with a configurable set of time-domain resources, e.g., a set of slots or symbols in which the corresponding subset of RS resources or RS resource indexes of the set of RLM-RS resources for radio link monitoring are provided to the UE. A UE may also be provided by higher layers an association between slots or symbols for radio link quality evaluation and an RLM-RS subset. Alternatively, an association between slots and symbols or an RLM-RS subset may be indicated through the time-domain resource allocation of the RS resources or RS resource indices configured for an RLM-RS subset.

A set of RLM-RS resources may be configured on non-SFBD slots or symbols and on SBFD slots or symbols. An RLM-RS subset may be configured on SFBD slots or symbols. The UE performs radio link monitoring using the RS of an RLM-RS subset for the associated time-domain resources, e.g., slots or symbols. When evaluating DL radio link quality, the UE indicates out-of-sync and in-sync, respectively, to higher layers for an RLM-RS subset separately from the out-of-sync or in-sync indications issued to higher layers for the set of RLM-RS resources. The UE may indicate out-of-sync for an RLM-RS subset while indicating in-sync for the set of RLM-RS resources, or the UE may indicate in-sync for the RLM-RS subset and the set of RLM-RS resources, or the UE may indicate that the RLM-RS subset and the set of RLM-RS resources are out-of-sync.

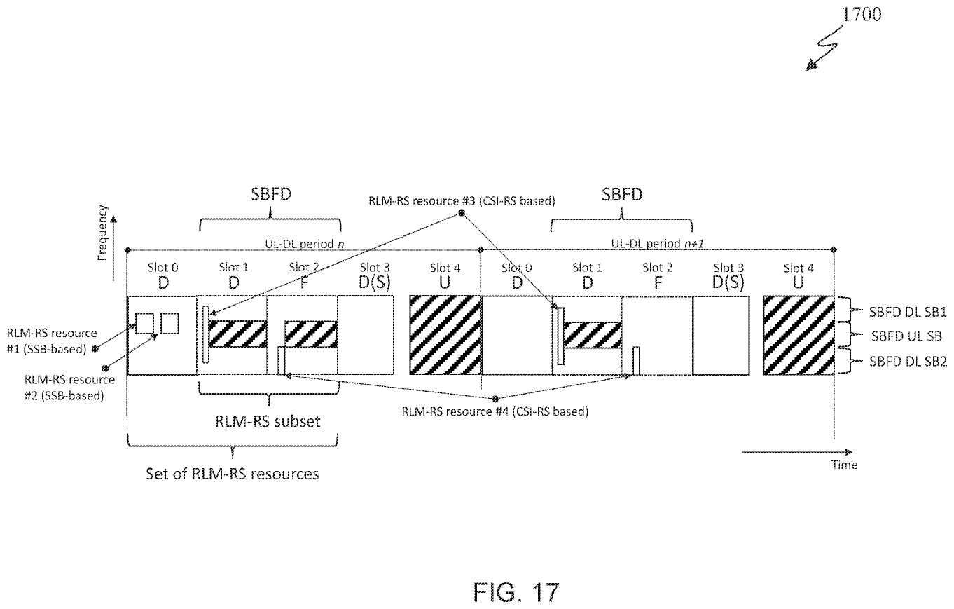

FIG. 17 illustrates an example diagram of a full-duplex communication system 1700 using an RLM-RS subset. The embodiment of a FD system using an RLM-RS subset illustrated in FIG. 17 is for illustration only. FIG. 17 does not limit the scope of this disclosure to any particular implementation of a FD communication system 1700.

For example, on each RLM-RS resource of an RLM-RS subset, the UE may estimate the DL radio link quality and may compare it to the thresholds Qₒᵤₜ and Qᵢₙ for the purpose of monitoring DL radio link quality of the configured RLM-RS subset and its associated time-domain resources in a serving cell. The physical layer in the UE indicates, in frames where the radio link quality is assessed, out-of-sync to higher layers for the time-domain resources associated with an RLM-RS subset when the radio link quality is worse than the threshold Qₒᵤₜ for all resources in the RLM-RS subset for radio link monitoring. When the radio link quality is better than the threshold Qᵢₙ for any resource in the RLM-RS subset, the physical layer in the UE indicates, in frames where the radio link quality is assessed, in-sync to higher layers for the time-domain resources associated with an RLM-RS subset.

For example, the set of RLM-RS resources is configured with N_{RLM}=4 reference signals in both non-SBFD slots or symbols and in SBFD slots or symbols. The subset of RLM-RS resources is configured with M=2 reference signals in SBFD slots or symbols. The UE indicates out-of-sync for the set of RLM-RS resources when all N_{RLM}=4 reference signals associated with the set of RLM-RS resources indicate out-of-sync. The UE indicates in-sync for the set of RLM-RS resources when any reference signal associated with the set of RLM-RS resources indicates in-sync. The UE indicates out-of-sync for the RLM-RS subset when all M=2 reference signals associated with the RLM-RS subset indicate out-of-sync. The UE indicates in-sync for the RLM-RS subset when any reference signal associated with the RLM-RS subset indicates in-sync.

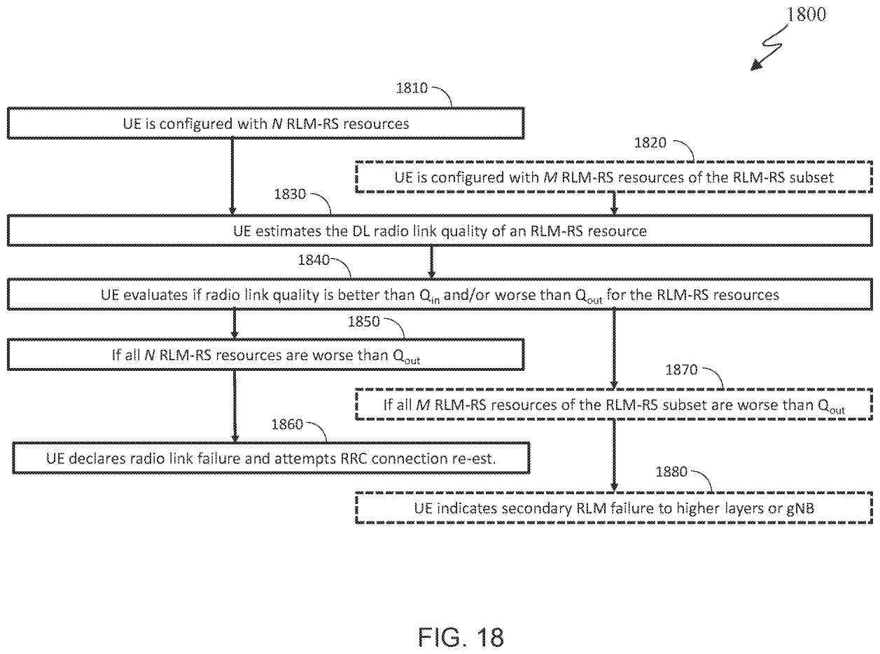

FIG. 18 illustrates an example process flowchart of a method 1800 of a full-duplex communication system using an RLM-RS subset to evaluate radio link quality. The embodiment of the method 1800 of a FD communication system using an RLM-RS subset to evaluate radio link quality illustrated in FIG. 18 is for illustration only. FIG. 18 does not limit the scope of this disclosure to any particular implementation of the method 1800.

The method 1800 begins with the UE being configured with N RLM-RS resources, 1810. The UE is also configured with M RLM-RS resources of the RLM-RS subset, 1820. The UE estimates the DL radio link quality of an RLM-RS resource, 1830. The UE evaluates if radio link quality is better than Qᵢₙ and/or worse than Qₒᵤₜ for the RLM-RS resource, 1840. If it is determined if all N RLM-RS resources are worse than Qₒᵤₜ, 1850, then the UE declares radio link failure and attempts RRC connection reset 1850. If it is determined if all M RLM-RS resources of the RLM-RS subset are worse than Qₒᵤₜ, 1870, then the UE indicates secondary RLM failure to higher layers or a gNB, 1880.

Advantageously, the RLM-RS subset can be configured for the UE to evaluate the radio link quality separately and to indicate the radio link quality separately to higher layers for the set of SBFD slots or symbols and for the set of normal DL slots or symbols. For an RLM-RS subset configured on SBFD slots or symbols, the UE physical layer then indicates, in frames where the radio link quality is assessed, out-of-sync to higher layers separately when the radio link quality is evaluated worse than the threshold Qₒᵤₜ for all RS resources in the set of configured RS resources in the RLM-RS subset on SBFD slots or symbols. Out-of-sync for DL receptions of configured resources of the set of RLM-RS resources on non-SBFD/SBFD slots or symbols may occur at a different time, such as for example later than out-of-sync for DL receptions of configured resources in the RLM-RS subset on SBFD slots or symbols due to more favorable Rx SINR conditions in the former. Similar considerations apply to the ability of the UE to issue separate in-sync indications for the set of RLM-RS resources and the RLM-RS subset, respectively. It is another advantage that radio link failure, or inability to receive at least an assumed small payload size for a reference DCI format with assumed hypothetical PDCCH transmission parameters, is separately reportable to UE higher layers or the gNB. Out-of-sync for the RLM-RS subset on SBFD slots or symbols can be detected by the UE physical layer and indicated to higher layers and can be reported separately to the gNB.

The UE determines a set of RLM-RS resources RLM-RS₁ and an RLM-RS subset RLM-RS₂ for radio link monitoring in a serving cell. The set of RLM-RS resources RLM-RS₁ for a serving cell is associated with RS(s) configured for the UE in a first set of slots or symbols of the serving cell. The RLM-RS subset RLM-RS₂ for a serving cell is associated with RS(s) configured for the UE in a second set of slots or symbols on the serving cell. The second set of slots or symbols may be contained in the first set of slots or symbols. On the RLM-RS resource(s) in the set of RLM-RS resources and the RLM-RS subset, the UE estimates the DL radio link quality and compares it to the thresholds Qₒᵤₜ and Qᵢₙ for the purpose of monitoring DL radio link quality of the cell in one or multiple slots or symbols. The UE evaluation of the radio link quality thresholds Qₒᵤₜ and Qᵢₙ, respectively, may account for an evaluation or indication period. The length, duration or criteria associated with an evaluation or indication period for the set of RLM-RS resources RLM-RS₁ and the RLM-RS subset RLM-RS₂, respectively, may be indicated or specified by same parameters or by separate parameters.

A set of RLM-RS resources and an RLM-RS subset, RLM-RS₁ and RLM-RS₂ respectively, associated with RS(s) in different RLM-RS slot/symbol groups may be provided to the UE by one or a combination of RRC signaling and/or configuration, MAC CE signaling, L1 control signaling by DCI, or tabulated and/or listed by system operating specifications.

It is also possible that only a set of RLM-RS resources RLM-RS₁ associated with a first set of time-domain resources, e.g., slots or symbols, is provided to the UE by RRC whereas the UE determines an RLM-RS subset RLM-RS₂ associated with a second set of time-domain resources, e.g., slots or symbols, from, e.g., L1 control signaling by DCI. The determination of an RLM-RS subset RLM-RS₂ associated with a second set of time-domain resources, e.g., slots or symbols, may depend on and be a function of the set of RLM-RS resources RLM-RS₁. For example, the UE may determine some or all RS resources or RS resource indices for RLM-RS₂ as a set of RS resources or RS resource indices configured with respect to or as function of a set of RS resources or RS resources indices configured for RLM-RS₁.

The RS resources in the set of RLM-RS resources and in the RLM-RS subset, RLM-RS₁ and RLM-RS₂ respectively, on a serving cell may be provided to or determined by the UE by means of RS resource indices. For example, an RS resource index may correspond to an SSB index, or a CSI-RS resource index, or a TCI state for PDCCH reception that includes one or more CSI-RS.

For example, the RS resources or RS resource indices of set of RLM-RS resources or the RLM-RS subset may be included in one or more signaling messages and/or IEs. For example, and without loss of generality, the gNB may provide these to the UE as part of RRC signaling messages of type RRCSetup, RRCReconfiguration, SIB1 or SystemInformation and or may provide such configuration in RRC IEs of type ServingCellConfig, ServingCellConfigCommon, or ServingCellConfigSIB1 where an RRC configuration parameter may be of enumerated, listed or sequence type and/or may be encoded as a bit string.

For a set of RLM-RS resources RLM-RS₁ and an RLM-RS subset RLM-RS₂ on a serving cell, the UE may be provided up to N_{LR-RLM} and M RadioLinkMonitoringRS, respectively, for link recovery procedures and for radio link monitoring. A maximum value of N_{LR-RLM} can be same as for a UE not supporting full-duplex/SBFD operation or a new UE capability can be defined and a maximum value of N_{LR-RLM} can be larger for a UE supporting full-duplex/SBFD operation than for a UE not supporting full-duplex/SBFD operation. From the N_{LR-RLM} RadioLinkMonitoringRS, up to N_{RLM} RadioLinkMonitoringRS can be used for radio link monitoring depending on L_{MAX} as described in REF3, and up to two RadioLinkMonitoringRS can be used for link recovery procedures.

The UE may determine the DL radio link quality for DL receptions in a slot or symbol using either the set of RLM-RS resources RLM-RS₁ or the RLM-RS subset RLM-RS₂. A resource from the set of RLM-RS resources RLM-RS₁ may be used by the UE to determine DL reception quality in a normal DL slot or symbol, e.g., non-SBFD slots or symbols. A resource from the RLM-RS subset RLM-RS₂ may be used by the UE to determine DL reception quality in a full-duplex or SBFD slot or symbol.

The UE may determine the DL reception quality in a slot or symbol using a same RS resource or RS resource index configured in both the set of RLM-RS resources RLM-RS₁ and the RLM-RS subset RLM-RS₂. A signaling condition or priority rule(s) may then be used by the UE to include the same RS resource or RS resource index in a particular occurrence, e.g., slot or symbol, in the radio link quality evaluation.

For example, a same RS resource or RS resource index associated with the set of RLM-RS resources and the RLM-RS subset may be configured on a flexible slot or symbol. When the UE determines the flexible slot or symbol to be scheduled or configured by the gNB for DL-only transmissions, the UE includes the same RS resource or RS resource index as part of the radio link quality evaluation for the set of RLM-RS resources, e.g., assuming the flexible slot or symbol is used for non-SBFD transmission. When the UE determines the flexible slot or symbol to be scheduled or configured by the gNB for both DL and UL transmissions, the UE includes the same RS resource or RS resource index as part of the radio link quality evaluation for the RLM-RS subset, e.g., assuming the flexible slot or symbol is used for SBFD transmissions and receptions. When the UE receives a DCI format scheduling transmission or reception on a slot or symbol, the UE selects the set of RLM-RS resources or the RLM-RS subset, respectively, to determine the radio link quality using the associated RS resource or RS resource index of the set of RLM-RS resources or the RLM-RS subset in that slot or symbol.

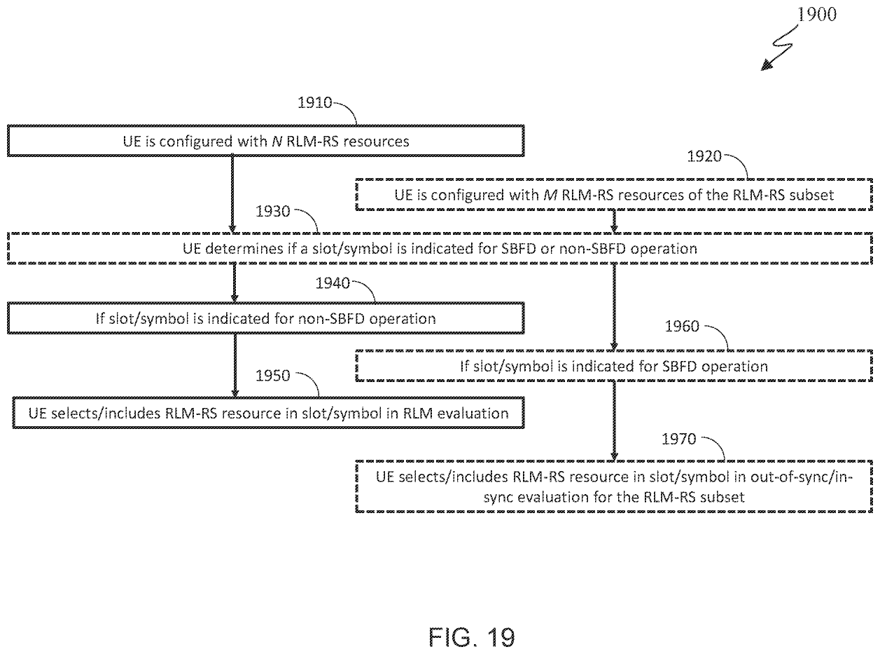

FIG. 19 illustrates an example process flowchart of a method 1900 of a full-duplex communication system using a slot/symbol type to select an RLM-RS subset. The embodiment of the method 1900 of a FD communication system using slot/symbol type to select an RLM-RS subset illustrated in FIG. 19 is for illustration only. FIG. 19 does not limit the scope of this disclosure to any particular implementation of the method 1900.

The method 1900 begins with a UE being configured with N RLM-RS resources, 1910. The UE is configured with M RLM-RS resources of the RLM-RS subset, 1920. The UE determines if a slot/symbol is indicated for SBFD or non-SBFD operation, 1930. If the slot/symbol is indicated for non-SBFD operation, 1940, then the UE selects or includes RLM-RS resource in slot/symbol in RLM evaluation, 1950. If the slot/symbol is indicated for SBFD operation, 1960, then the UE selects/includes RLM-RS resource in slot/symbol in out-of-syn.in-sync evaluation for the RLM-RS subset, 1970.

For example, the UE selects the set of RLM-RS resources, or the RLM-RS subset associated with radio link quality evaluation in a slot or symbol based on a slot or symbol type in a time period. The slot type may include one or a combination of the following,
slot or symbol of type D (Downlink), U (Uplink) or F (Flexible) in a TDD common or dedicated UL-DL frame configuration or provided through SFI such as in DCI F2_0;
slot or symbol of type ‘simultaneous Tx-Rx’, ‘Rx only’, or ‘Tx only’, e.g., associated with a cell common or a UE dedicated slot and/or symbol configuration providing a resource or transmission type indication; or
slot or symbol associated with a full-duplex UL transmission resource or SBFD UL subband configuration or a full-duplex DL transmission resource or SBFD DL subband configuration; or
slot or symbol assignment provided to the UE by DCI scheduling.

For example, the UE selects the RLM-RS subset RLM-RS₂ for radio link quality monitoring evaluation using a configured RS resource or RS resource index in a slot or symbol that is provided, for example, by a higher layer provided parameter fd-config. The UE determines the resource type configuration of a serving cell by receiving a system information block (SIB), such as a SIB1, or by a common RRC signaling, or by UE-specific RRC signaling. For example, the resource type indication provided to the UE by higher layers indicates for a slot or symbol or symbol group of the transmission resource may be of type ‘simultaneous Tx-Rx’, ‘Rx only’, or ‘Tx only’. For example, a transmission resource of type ‘simultaneous Tx-Rx’, ‘Rx only’, or ‘Tx only’ can be provided per slot type ‘D’, ‘U’ or ‘F’ in a slot. For example, the transmission resource may be configured with an SBFD UL and/or DL subband. The indication of the resource type may be provided independently/separately of the transmission direction of a slot or symbol indicated to the UE by the TDD UL-DL frame configuration provided by higher layers. If the determined slot or symbol type of a slot or symbol for radio link quality evaluation is ‘non-SBFD’, the UE selects the set of RLM-RS resources RLM-RS₁. If the determined slot or symbol type of a slot or symbol for radio link quality evaluation is ‘SBFD’, the UE selects the RLM-RS subset RLM-RS₂.

A motivation is that by determining a slot or symbol as type ‘non-SBFD’ versus ‘SBFD’, the UE may distinguish between slots or symbols in which it may assume only DL transmissions occur versus slots in which it cannot make any assumption of the DL and/or UL scheduling decisions by the gNB. Accordingly, the UE should select and use the RLM-RS subset RLM-RS₂ for radio link quality evaluations in the full-duplex or SBFD slot or symbol. After the selection of the set of RLM-RS resources or the RLM-RS subset by the UE in a slot or symbol for radio link quality evaluation, the associated in-sync and/or out-of-sync criterion is applied to determine if an in-sync or out-of-sync indication for an RLM-RS resource from the set of RLM-RS resources or the RLM-RS subset in that slot or symbol should be indicated to higher layers.

In one embodiment, the UE signals a secondary radio link monitoring failure indication to higher layers and/or the gNB using UL signaling when all RS resources or RS resource indices associated with the RLM-RS subset indicate out-of-sync. The UE signals a secondary radio link monitoring re-establishment indication to higher layers and/or the gNB using UL signaling when any RS resource or RS resource indices associated with the RLM-RS subset indicate in-sync.

For example, the set of RLM-RS resources is configured with N_{RLM}=4 reference signals in both non-SBFD slots or symbols and in SBFD slots or symbols. The subset of RLM-RS resources is configured with M=2 RS resources in SBFD slots or symbols. For each RLM-RS resource from the set of RLM-RS resources or from the RLM-RS subset, the UE may estimate the DL radio link quality and may compare it to a respective threshold Qₒᵤₜ or Qᵢₙ for the purpose of monitoring DL radio link quality. The threshold Qₒᵤₜ or Qᵢₙ can be separately provided to the UE for different time resources, such as for normal DL slots and for full-duplex/SBFD slots. The physical layer in the UE indicates, in frames where the radio link quality is assessed, out-of-sync to higher layers for the time-domain resources associated with an RLM-RS resource when the radio link quality is worse than the threshold Qₒᵤₜ for all resources in the set of RLM-RS resources for radio link monitoring. When the radio link quality is better than the threshold Qᵢₙ for any resource in the set of RLM-RS resources for radio link monitoring, the physical layer in the UE indicates, in frames where the radio link quality is assessed, in-sync to higher layers for the time-domain resources associated with the RLM-RS resources. For an RLM-RS subset for radio link monitoring, the UE transmits a secondary radio link monitoring failure indication in the UL using PUCCH, PUSCH, RACH or SRS, when the radio link quality is worse than the corresponding threshold Qₒᵤₜ for all RS resources or RS resource indices in the RLM-RS subset. For an RLM-RS subset for radio link monitoring, the UE may transmit a secondary radio link monitoring re-establishment indication in the UL using PUCCH, PUSCH, RACH or SRS, when the radio link quality is better than the corresponding threshold Qᵢₙ for any RS resource or RS resource index in the RLM-RS subset. The UE does not initiate the RRC re-establishment procedure when out-of-sync is indicated for all RS resources or RS resource indices associated with the RLM-RS subset. For example, the UE may initiate fallback operation, e.g., continue using only a limited set of DL/UL radio resources such as those associated with the non-SBFD slots or symbols the set of RLM-RS resources indicates in-sync. When out-of-sync is indicated by the UE to higher layers for the set of RLM-RS resources, the UE considers radio link failure to be detected, and attempts RRC connection re-establishment. Different counter and timer values may be associated with the set of RLM-RS resources and the RLM-RS subset. For example, the set of RLM-RS resources may be configured with RRC counter N310 or RRC timer T310 values, e.g., follow radio link failure detection procedures. The RLM-RS subset may be configured with other, possibly distinct, RRC counter or RRC timer values to determine the amount of time and number of occurrences before the UE transmits the radio link monitoring failure or re-establishment indication(s).

A UE may indicate a radio link monitoring failure or re-establishment indication for the RLM-RS subset using one or a combination of RRC signaling. MAC CE signaling, or L1 control signaling. The UE may indicate a radio link monitoring failure or re-establishment indication using PUCCH, PUSCH, RACH or SRS.

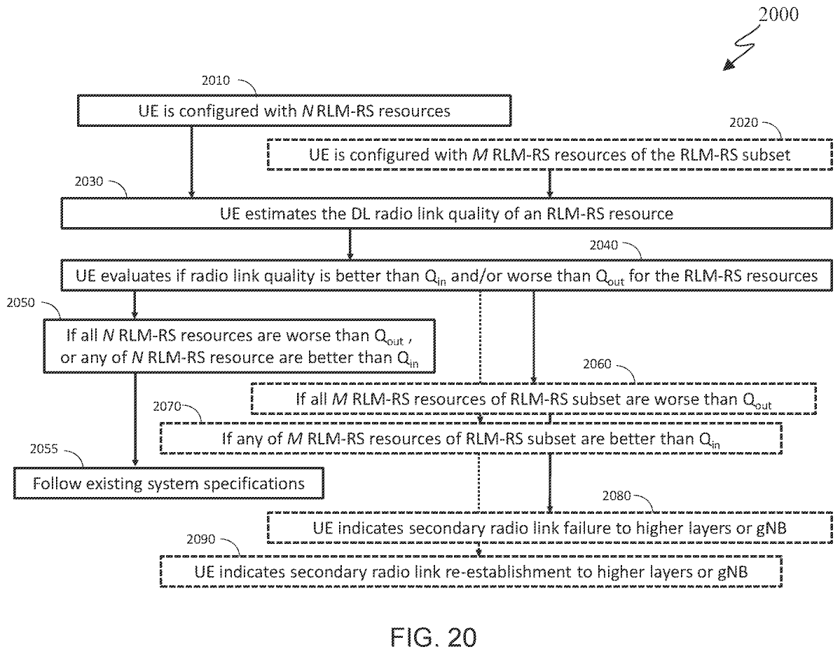

FIG. 20 illustrates an example process flowchart of a method 2000 of a full-duplex communication system using an RLM-RS subset to indicate secondary radio link monitoring failure or re-establishment. The embodiment of the method 2000 of a FD communication system using an RLM-RS subset to indicate secondary radio link monitoring failure or re-establishment illustrated in FIG. 20 is for illustration only. FIG. 20 does not limit the scope of this disclosure to any particular implementation of the method 2000.

The method 2000 begins with the UE being configured with N RLM-RS resources, 2010. The UE is configured with M RLM-RS resources of the RLM-RES subset, 2020. The UE estimates the DL radio link quality of an RLM-RS resource, 2030. The UE evaluates if radio link quality is better than Qᵢₙ and/or worse than Qₒᵤₜ for the RLM-RS resources, 2040. If all N RLM-RS resources are worse than Qₒᵤₜ, or if any of N RLM-RS resources are better than Qᵢₙ, 2050, then the UE follows existing system specifications, 2055. If all M RLM-RS resource of RLM-RS subset are worse than Qₒᵤₜ, 2060, then UE indicates secondary radio link failure to higher layers or gNB. If any of M RLM-RS resources of RLM-RS subset are better than Qᵢₙ, 2070, then the UE indicates secondary radio link re-establishment to higher layers or gNB, 2090.

Advantageously, out-of-sync and in-sync for the RLM-RS subset on SBFD slots or symbols can be detected and indicated by the UE physical layer to higher layers and can be reported separately to the gNB. The gNB may then apply necessary actions, e.g., DL/UL scheduling may still be possible on a limited set of non-SBFD slots or symbols while the set of RLM-RS resources indicates in-sync due to more favorable Rx SINR conditions. The UE may not need to initiate RRC connection re-establishment procedures while the set of RLM-RS resources indicates in-sync, and the DL/UL data scheduling does not need to be interrupted.

In additional embodiments of this disclosure for facilitation of radio link monitoring in FD systems, the UE is provided a fallback signaling indication by the gNB using DCI or higher layer signaling such as MAC-CE or RRC. A fallback signaling indication is associated with further transmissions or receptions to/from the UE using a restricted or limited set of time-domain resources, e.g., symbols/slots, or using a restricted or limited set of frequency-domain resources, e.g., SBFD subbands, BWPs, RB sets. A fallback signaling indication may be associated with an activation time, an activation or processing delay, or a reference timing when the transmission or reception configuration takes effect. A fallback signaling indication may be associated with a condition, where a UE evaluates the condition before the UE validates or applies (or does not validate or apply) a received fallback signaling indication.

For example, the UE may be provided information for a set of RLM-RS resources using N_{RLM}=4 reference signals in both non-SBFD slots or symbols and in SBFD slots or symbols. A subset of the N_{RLM}=4 RLM-RS resources may be configured with M=2 RS resources in SBFD slots or symbols. For each RLM-RS resource from the set of RLM-RS resources or from the RLM-RS subset, the UE may estimate the DL radio link quality and compare it to a respective threshold Qₒᵤₜ or Qᵢₙ for the purpose of monitoring DL radio link quality. A threshold Qₒᵤₜ or Qᵢₙ may be provided separately to the UE for different time resources, such as for non-SFBD slots and for SBFD slots, or a single threshold Qₒᵤₜ or Qᵢₙ may be provided to the UE.

The physical layer in the UE evaluates radio link quality conditions. In frames where the radio link quality is assessed, the UE physical layer indicates out-of-sync to higher layers for the time-domain resources associated with an RLM-RS resource when the radio link quality is worse than the threshold Qₒᵤₜ for all resources in the set of RLM-RS resources for radio link monitoring. When the radio link quality is better than the threshold Qᵢₙ for any resource in the set of RLM-RS resources for radio link monitoring, the physical layer in the UE indicates, in frames where the radio link quality is assessed, in-sync to higher layers for the time-domain resources associated with the RLM-RS resources.

For a reference signal in an RLM-RS subset for radio link monitoring, a UE may provide a separate or a secondary radio link monitoring failure indication to the gNB in the UL using PUCCH, PUSCH, RACH or SRS, when the radio link quality is worse than the corresponding threshold Qₒᵤₜ for all RS resources, or RS resource indices, in the RLM-RS subset on the SBFD slots. A UE may measure or evaluate a L1 measurement quantity, a L3 filtered measurement report value, or a metric based on a measurement in the SBFD slots/symbols associated with a signal power or signal quality or an interference level and provide a signaling indication to the gNB using a L1, MAC-CE, or RRC signaling message. A gNB may evaluate and determine DL radio link conditions in the SBFD slots/symbols using performance statistics such as based on an estimated PDCCH missed detection rate/ratio, e.g., based on absence of corresponding received PUCCH transmissions from the UE associated with PDSCHs scheduled by PDCCHs, or such as based on a received signal power or a received signal quality measurement for transmissions from the UE, or such as based on an assumed DL-UL signal reciprocity for at least some propagation characteristics.

A UE may not initiate an RRC re-establishment procedure when out-of-sync is indicated by UE physical layer for RS resources, or RS resource indices, associated with the RLM-RS subset on the SBFD slots while in-sync is indicated for RLM-RS resources in non-SBFD slots/symbols. A gNB may determine that transmissions to the UE in SBFD symbols/slots should not be scheduled or configured, e.g., due to unfavorable SINR or link conditions at the UE on these slots or symbols. A gNB may provide a fallback signaling indication to the UE associated with transmissions from the gNB to the UE being restricted or being limited to a non-SBFD slot/symbol. For example, the gNB may restrict the resources that are usable for scheduling transmissions to the UE. For example, the gNB may use DCI-based signaling, such as a PDCCH monitoring adaptation field in a DCI, to adjust the UE PDCCH reception behavior using PDCCH skipping and/or SSSG switching. For example, a separate field may be included in a DCI format scheduling PDSCH reception to the UE or PUSCH transmission from the UE, where the field indicates whether or not the UE shall monitor PDCCH on SBFD symbols/slots. The UE may initiate a fallback operation mode, e.g., the UE receives using only a limited set of radio resources in time-domain and/or frequency-domain. A limited set may correspond or be associated with one or more non-SBFD slots/symbols or may be associated with a selected SBFD subband while UE physical layer indicates in-sync for an RLM-RS resource associated with a radio resource.

A UE may autonomously initiate a fallback operation mode when the UE determines radio link failure conditions for an RLM-RS resource associated with an SBFD slot/symbol. For example, the UE may determine parameters for receptions or transmissions based on a first RRC configuration provided by the gNB to the UE for the case when transmissions and receptions in both non-SBFD and SBFD slots/symbols are possible, and the UE may determine parameters for receptions or transmissions based on a second RRC configuration for the case that transmissions and receptions using a limited set are possible.

When out-of-sync is indicated by the UE physical layer to higher layers for the set of all RLM-RS resources, the UE considers radio link failure to be detected, and may attempt an RRC connection re-establishment procedure. Different counter and timer values may be associated with the set of RLM-RS resources and the RLM-RS subset, respectively. For example, the set of RLM-RS resources may be configured with RRC counter N310 or RRC timer T310 values, e.g., follow existing radio link failure detection procedures. The RLM-RS subset for which a UE is provided information with respect to an SBFD slot/symbol may be parameterized with a second RRC counter or RRC timer value to determine the amount of time and number of occurrences before the UE provides a secondary radio link failure notification or provides measurement metrics associated with a reception in an SBFD slot/symbol to the gNB.

A motivation is that when unfavorable radio link quality conditions are detected by the UE, e.g., using UE-based evaluation of out-of-sync and in-sync conditions for an RLM-RS subset on an SBFD slot/symbol, or when using gNB-based evaluation of radio link conditions with respect to the UE using a gNB-side observable measurement or performance statistic, the gNB may then apply necessary actions to avoid interruption of the radio link between gNB and UE.

For example, PDCCH or PDSCH transmissions to a UE at cell edge may still be possible when using a limited or restricted set of non-SBFD slots/symbols when the UE physical layer indicated in-sync for the set of RLM-RS resources associated with the non-SBFD slots/symbols due to more favorable Rx SINR at the UE on these slots/symbols. A fallback signaling indication provided by the gNB to the UE may instruct the UE to restrict PDCCH or PDSCH receptions to a restricted set of time-domain and/or frequency-domain radio resources. The UE does not need to declare RLF and initiate an RRC connection re-establishment procedure while an RLM-RS resource associated with a restricted set of radio resources satisfies in-sync conditions. Then, out-of-sync indications by the UE physical layer for slots/symbols with received small SINR, e.g., an SBFD slot/symbol, does not result in an interruption of transmission/receptions by the UE. PUCCH or PUSCH transmissions from a UE to a gNB on the serving cell supporting full-duplex operation may be accordingly configured or scheduled, e.g., a gNB may provide information to a UE to transmit using PUCCH or PUSCH repetitions. This may reduce the number of symbols used by the gNB for transmissions and may increase the number of symbols used by the gNB for receptions.

For example, a UE may be provided a fallback signaling indication by the gNB using higher layer signaling such as RRC or MAC-CE.

A UE may be provided information for a fallback signaling indication included in one or more RRC messages and/or IEs. For example, a fallback signaling indication may correspond to signaling re-configuring the UE receptions or transmissions to a limited or restricted set of time-domain radio resources. For example, a fallback signaling indication may correspond to a first and a second radio configuration provided by the gNB to the UE where the first radio configuration is used by the UE when receptions or transmissions using both non-SBFD and the SBFD slots/symbols are possible, and where the second radio configuration is used by the UE when receptions or transmissions only using the limited or restricted set are possible.

For example, a fallback signaling indication may be received by the UE by common RRC signaling such as using a cell-common RRC configuration or using a system information block (SIB) or may be received by the UE by UE-specific RRC signaling. For example, a fallback signaling indication may be provided by the gNB to the UE as part of RRC messages of type RRCSetup, RRCReconfiguration, SIB1 or SystemInformation, or may be included in RRC IEs of type ServingCellConfig, ServingCellConfigCommon, or ServingCellConfigSIB1. Such RRC configuration parameters may be of enumerated, listed or sequence type or may be encoded as a bit string.

For example, a fallback signaling indication may be associated with slot/symbol indices or a set of slots/symbols where receptions or transmissions are allowed or not allowed. For example, a fallback signaling indication may be associated with and include a slot or symbol type, e.g., ‘D’ or ‘F’ or ‘D and F’, or ‘SBFD’ or ‘non-SBFD’, or {‘any’, ‘non-SBFD only, ‘SBFD only’ } or may be associated with an include an SBFD subband type, e.g., ‘DL subband’ or ‘UL subband’ or ‘Flexible subband’ or {‘any’, ‘DL subband only’ } to indicate a restricted or limited set. The UE may be provided time-domain resources, e.g., slots/symbols, where the UE is allowed or is not allowed receptions or transmissions. For example, the UE may be provided a list or sequence or bitmap representative of M slots/symbols from the set of N slots/symbols in a period p. A UE may determine a subset of M slots/symbols from the set of N slots/symbols as allowed or not allowed for receptions or transmissions using a restricted or limited set of time-domain radio resources. For example, the UE may determine the first or the last M slots/symbols from a set of N slots/symbols as a limited or restricted set. For example, M may be 1 or M may be associated with default values. Multiple subsets of slots/symbols may be provided to the UE or be determined by the UE.

A fallback signaling indication providing information on a limited or restricted set may be associated with a bitmap to indicate allowed or dis-allowed time-domain radio resources, such as based on an existing RRC parameter monitoringSlots WithinSlotGroup or monitoringSymbolsWithinSlot, or a frequency-domain resource based on an existing RRC parameter freqMonitorLocations. A fallback signaling indication may be associated with a resource type indication to indicate allowed or dis-allowed slots or symbols, such as a slot or symbol or symbol group of a radio resource that may be of type ‘simultaneous Tx-Rx’, ‘Rx only’, or ‘Tx only’. For example, a transmission resource of type ‘simultaneous Tx-Rx’, ‘Rx only’, or ‘Tx only’ can be provided per slot type ‘D’, ‘U’ or ‘F’ in a slot. For example, a radio resource in a restricted or limited set may be associated with a configured or an indicated SBFD UL and/or DL subband. An indication of the resource type may be provided independently of the transmission direction of a slot or symbol indicated to the UE by the TDD UL-DL frame configuration provided by higher layers.

As can be seen by someone skilled in the art, a similar design as described can be applied when MAC-CE based higher-layer signaling is used to provide information on a fallback signaling indication to a UE.

For example, a UE may be provided a fallback signaling indication by the gNB using a DCI. An indication value associated with a fallback signaling indication may then be provided to the UE using a unicast DCI, e.g., using DCI format 1_0/1_1/1_2. An existing IE in a DCI may be used to provide an indication value associated with the fallback signaling indication to a UE, e.g., using an unused codepoint, or a new IE may be used.

For example, when a PDCCH monitoring adaptation field of size M=2 bits is configured for the UE in a DCI F1_1 or F1_2 and the set of durations provided to the UE by parameter PDCCHSkippingDurationList includes one value for PDCCH monitoring by the UE according to Type-3 PDCCH CSS sets or USS sets on the active DL BWP of the serving cell, a ‘11’ value may be used for a fallback signaling indication. When the UE receives the fallback signaling indication, the UE applies the restricted or limited set of time-domain radio resources for further receptions.

A similar design as described for the example of using a reserved codepoint in an existing DCI field can be applied when a new IE of size M=1 or more bits is configured for the UE and used by the gNB to provide a DCI-based fallback signaling indication to the UE or when using other reserved codepoint(s) in existing DCI field(s).

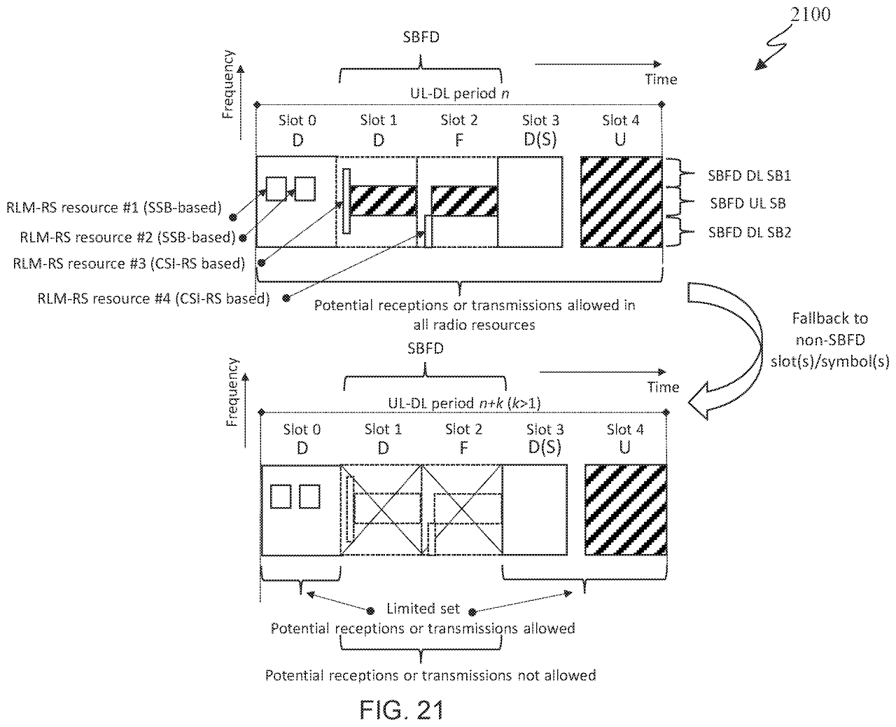

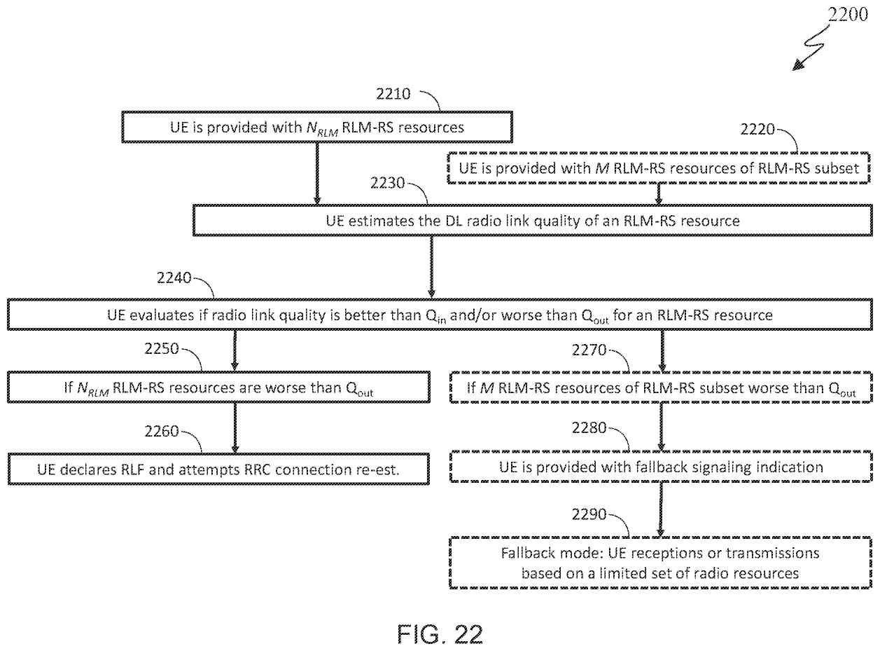

FIG. 21 illustrates an example block diagram 2100 of a fallback operation in a full-duplex communication system, according to embodiments of the disclosure. FIG. 22 illustrates an example process flowchart of a method 2200 of a fallback operation in a full-duplex communication system according to embodiments of the disclosure. The block diagram 2100 and the method 2200 illustrated in FIGS. 21 and 22, respectively, are for illustration only. Neither the block diagram 2100 or the method 2200 are limited by the example illustrations in FIGS. 21 and 22, respectively.

The method 2200 begins with the UE being provided with N_{RLM} RLM-RS resources, 2210. The UE is provided with M RLM-RS resources of RLM-RS subset, 2220. The UE estimates the DL radio link quality of an RLM-RS resource, 2230. The UE evaluates if the radio link quality is better than Qᵢₙ and/or worse than Qₒᵤₜ for an RLM-RS resource, 2240. If N_{RLM} RLM-RS resources are worse than Qₒᵤₜ, 2250, then the UE declares RLF and attempts RRC connected re-establishment, 2260. If M RLM-RS resources of RLM-RS subset is worse than Qₒᵤₜ, 2270, the UE is provided with a fallback signaling indication, 2280. In a fallback mode, UE receptions or transmissions based on a limited set of radio resource, 2290.

In one embodiment, a UE evaluates in-sync or out-of-sync for an SBFD slot or symbol using channel state information, e.g., CQI determined based on a CSI configuration provided to the UE for reporting CSI in an SBFD slot and using an indicated/determined adjustment factor.

For example, a UE is provided information on a NZP CSI-RS resource or resource set configuration and an associated CSI report configuration using the NZP CSI-RS resource or resource set on an SBFD slot or symbol. The UE is indicated or determines an adjustment factor Delta_{OOS} as an offset, or a scaling value with respect to a CQI value determined based on a NZP CSI-RS resource or resource set in order to evaluate out-of-sync on an SBFD slot or symbol. For example, the UE is indicated or determines an adjustment factor Delta_{IS} as an offset, or a scaling value with respect to a CQI value using a NZP CSI-RS resource or resource set for a CSI report in order to evaluate in-sync on an SBFD slot or symbol. The UE determines a Qₒᵤₜ or Qᵢₙ threshold with respect to an SBFD slot or symbol after scaling a respective CSI-RS reception power or signal quality of a NZP CSI-RS resource or resource set in an SBFD slot or symbol with the corresponding adjustment factor. For example, the UE adjusts the CSI-RS reception power or signal quality of a NZP CSI-RS resources in an SBFD slot or symbol by Delta_{OOS} to determine an adjusted reception power or signal quality to evaluate the out-of-sync criterion for an SBFD slot or symbol. For example, the UE adjusts the CSI-RS reception power or signal quality of a NZP CSI-RS in an SBFD slot or symbol by Deltas to determine an adjusted reception power or signal quality to evaluate the in-sync criterion for an SBFD slot or symbol. The UE then uses an adjusted reception power or signal quality and compares it to the thresholds Qₒᵤₜ and/or Qᵢₙ for the purpose of monitoring DL radio link quality for SBFD slots or symbols in a serving cell. The physical layer in the UE determines out-of-sync for an SBFD slot or symbol when the radio link quality is worse than the threshold Qₒᵤₜ. When the radio link quality is better than the threshold Qᵢₙ, the physical layer in the UE determines in-sync for an SBFD slot or symbol.

In more embodiments, a UE evaluates in-sync or out-of-sync for an SBFD slot or symbol using a L1 measurement quantity, a L3 filtered measurement value, or a metric based on PDCCH reception in an SBFD slots/symbols, e.g., based on a PDCCH DM-RS.

For example, a UE is provided information for a PDCCH DM-RS on an SBFD slot or symbol. The UE is indicated or determines an adjustment factor Delta_{OOS} as an offset or as a scaling value with respect to a PDCCH DM-RS reception signal power or a signal quality measurement value in order to evaluate out-of-sync for an SBFD slot or symbol. For example, the UE is indicated or determines an adjustment factor Delta_{IS} as an offset or a scaling value with respect to a PDCCH DM-RS reception signal power or signal quality measurement value in order to evaluate in-sync on an SBFD slot or symbol. The UE determines the Qₒᵤₜ or Qᵢₙ threshold for an SBFD slot or symbol after scaling a respective PDCCH DM-RS reception signal power or signal quality measurement value which the UE determines based on the PDCCH DM-RS in an SBFD slot or symbol using the adjustment factor. For example, the UE adjusts a PDCCH DM-RS reception signal power or signal quality measurement value based on the PDCCH DM-RS in a non-SBFD slot or symbol by Delta_{OOS} to determine an adjusted signal power or signal quality value to evaluate the out-of-sync criterion for an SBFD slot or symbol. For example, the UE adjusts the PDCCH DM-RS signal power or signal quality measurement value based on the PDCCH DM-RS in an SBFD slot or symbol by Delta_{IS} to determine an adjusted reception power or signal quality to evaluate the in-sync criterion for an SBFD slot or symbol. The UE then uses an adjusted reception power or signal quality and compares it to the thresholds Qₒᵤₜ and Qᵢₙ for the purpose of monitoring DL radio link quality for SBFD slots or symbols in a serving cell. The physical layer in the UE determines out-of-sync for an SBFD slot or symbol when the radio link quality is worse than the threshold Qₒᵤₜ. When the radio link quality is better than the threshold Qᵢₙ, the physical layer in the UE determines in-sync for an SBFD slot or symbol.

A motivation is that radio link quality evaluation can be configured for the UE to evaluate RLF conditions in SBFD slots or symbols by re-using an existing gNB transmission, such as a PDCCH transmission or a NZP CSI-RS transmission provided to the UE for CSI reporting. There is no need for a separate configuration of a first CSI-RS resource or resource set in an SBFD slot or symbol for radio link monitoring by a UE, e.g., configuration of an RLM/BFD dedicated CSI-RS resource set which is restricted to settings ‘noCDM’ from cdm-Type, only ‘one’ and ‘three’ from density, and only ‘1 port’ from nrofPorts when using existing technology. A UE can both evaluate the RLF conditions and perform CSI reporting using a second CSI-RS resource or resource set in an SBFD slot or symbol. This may reduce signaling overhead and may avoid simultaneous CSI processing constraints when implementing the UE modem to support SBFD operation on a serving cell. When a number of gNB transmitter antenna ports using a normal DL slot is larger than a number of gNB transmitter antenna ports using the DL subbands of an SBFD slot and other antenna panel design parameters are accounted for by the gNB, the difference between radio link quality evaluation based on an SSB-based RLM-RS resource and a PDCCH DM-RS or CSI-RS for CSI report based resource can be estimated by the network implementation and be provided as single offset or adjustment value to balance the expected RLM detection behavior by a UE.

The adjustment factor may correspond to an offset or a scaling value for a measurement. The adjustment factor may correspond to an out-of-sync or an in-sync block error rate (BLER) or to a corresponding parameter rlmInSyncOutOfSyncThreshold. For example, for evaluating in-sync, a BLER over non-SBFD symbols can be 1% and a BLER over SBFD symbols can be 10%. The adjustment factor may correspond to hypothetical PDCCH transmission parameters. For example, for evaluating in-sync, a CCE aggregation level for PDCCH reception over non-SBFD symbols can be 8 and a CCE aggregation level for PDCCH reception over SBFD symbols can be 16. The UE may be provided by the gNB, or through system specification, additional evaluation assumptions such as an assumed PDCCH DM-RS EPRE or an assumed CSI-RS power offset associated with an in-sync or an out-of-sync evaluation for RLM or BFD.

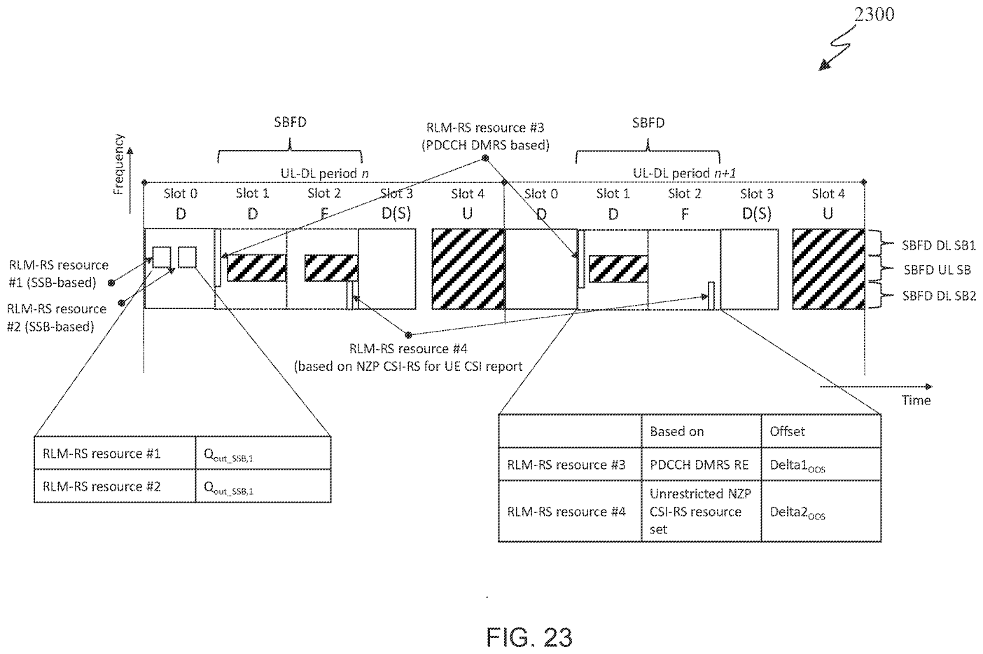

FIG. 23 illustrates an example diagram of a full-duplex communication system 2300 using PDCCH-based or CSI report-based radio link quality evaluation according to embodiments of the disclosure. The embodiment of a FD system PDCCH-based, or CSI report-based radio link quality illustrated in FIG. 23 is for illustration only. FIG. 23 does not limit the scope of this disclosure to any particular implementation of a FD communication system 2300.

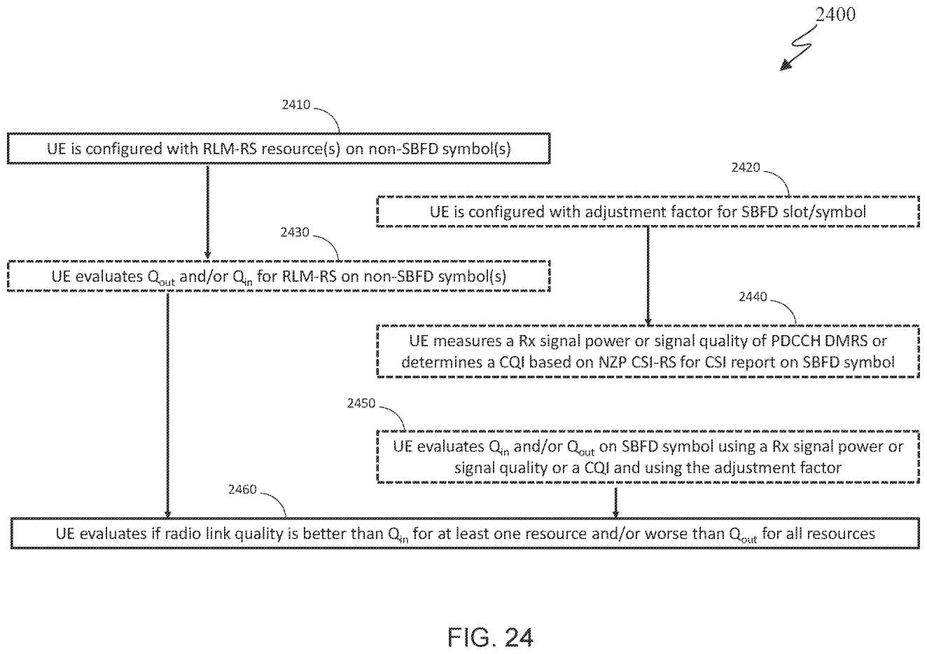

FIG. 24 illustrates an example flowchart of a method 2400 of a full-duplex communication system using PDCCH-based or CSI report-based radio link quality evaluation, according to embodiments of the disclosure. The embodiment of a FD system PDCCH-based, or CSI report-based radio link quality illustrated in FIG. 24 is for illustration only. FIG. 24 does not limit the scope of this disclosure to any particular implementation of the method 2400.

The method 2400 being with the UE being configured with RLM-RS resource(s) on non-SBFD symbol(s), 2410. The UE is configured with an adjustment factor for SBFD slot/symbol, 2420. The UE evaluates Qₒᵤₜ and/or Qᵢₙ for RLM-RS on non-SBFD symbol(s), 2430. The UE measures a Rx signal power or signal quality of PDCCH DMRS or determines a CQI based on NSP CSI-RS for CSI report on SBFD, 2440. The UE evaluates Qᵢₙ and/or Qₒᵤₜ on SUBFD symbol using a Rx signal power or signal quality of a CQI and using the adjustment factor, 2450. The UE evaluates if radio link quality is better than Qᵢₙ for at least resource and/or worse than Qₒᵤₜ for all resources, 2460.

What is claimed is:

1. A method of operating a user equipment, the method comprising:
receiving information for a set of radio link monitoring (RLM) reference signals (RSs) and a first set of parameters associated with an evaluation of the set of RLM RSs, wherein the set of RLM RSs corresponds to a first subset of slots from a set of slots on a cell;
receiving the set of RLM RSS;
determining, based on the first set of parameters, a first reception quality for a RLM RS from the first set of RLM RSS;
determining, based on the first reception quality and an adjustment value, a second reception quality for a second subset of slots from the set of slots on the cell; and
determining a radio link failure for the second subset of slots when the second reception quality is below a reception quality threshold for a second time period,
wherein the first subset of slots does not include time-domain resources indicated for simultaneous transmission and reception on the cell, and
wherein the second subset of slots includes time-domain resources indicated for simultaneous transmission and reception on the cell.

2. The method of claim 1, wherein:
determining the second reception quality further comprises determining the second reception quality by scaling a reception power of the RLM RS with the adjustment value, and
the adjustment value is an offset value.

3. The method of claim 1, further comprising:
determining a radio link failure for the first subset of slots based on a determination that the first reception quality is below a first reception quality threshold for a first time period; and
determining a radio link failure for the cell based on the determinations of the radio link failures for the first subset of slots and for the second subset of slots.

4. The method of claim 1, further comprising:
receiving a second set of parameters associated with the second subset of slots from the set of slots on the cell, wherein:
the first set of parameters include a first BLERₒᵤₜ,
the second set of parameters include a second BLERₒᵤₜ, and
determining the radio link failure for the second subset of slots further comprises determining the radio link failure for the second subset of slots based on the second reception quality using the second BLERₒᵤₜ.

5. The method of claim 1, further comprising:
receiving a second set of parameters associated with the second subset of slots from the set of slots on the cell, wherein:
the first set of parameters include a first T_{Evaluate_out},
the second set of parameters include a second T_{Evaluate_out}, and
determining the radio link failure for the second subset of slots further comprises determining the radio link failure for the second subset of slots based on the second reception quality using the second T_{Evaluate_out}.

6. The method of claim 1, wherein:
the set of RLM RSs includes a first and a second RLM RS,
the first set of parameters includes a first value and a second value corresponding to a first
parameter from the first set of parameters, and
the first and second values correspond to the first and second RLM RSs, respectively.

7. A user equipment (UE) comprising:
a transceiver configured to:
receive information for a set of radio link monitoring (RLM) reference signals (RSs) and a first set of parameters associated with an evaluation of the set of RLM RSs, wherein the set of RLM RSs corresponds to a first subset of slots from a set of slots on a cell; and
receive the set of RLM RSs; and
a processor operably coupled with the transceiver, the processor configured to:
determine, based on the first set of parameters, a first reception quality for a RLM RS from the first set of RLM RSS;
determine, based on the first reception quality and an adjustment value, a second reception quality for a second subset of slots from the set of slots on the cell; and
determine a radio link failure for the second subset of slots when the second reception quality is below a reception quality threshold for a second time period,
wherein the first subset of slots does not include time-domain resources indicated for simultaneous transmission and reception on the cell, and
wherein the second subset of slots includes time-domain resources indicated for simultaneous transmission and reception on the cell.

8. The UE of claim 7, wherein:
the processor is further configured to determine the second reception quality by scaling a reception power of the RLM RS with the adjustment value, and
the adjustment value is an offset value.

9. The UE of claim 7, wherein the processor is further configured to:
determine a radio link failure for the first subset of slots based on a determination that the first reception quality is below a first reception quality threshold for a first time period; and
determine a radio link failure for the cell based on the determinations of the radio link failures for the first subset of slots and for the second subset of slots.

10. The UE of claim 7, wherein:
the transceiver is further configured to receive a second set of parameters associated with the second subset of slots from the set of slots on the cell,
the first set of parameters include a first BLERₒᵤₜ,
the second set of parameters include a second BLERₒᵤₜ, and
the processor is further configured to determine the radio link failure for the second subset of slots based on the second reception quality using the second BLERₒᵤₜ.

11. The UE of claim 7, wherein:
the transceiver is further configured to receive a second set of parameters associated with the second subset of slots from the set of slots on the cell,
the first set of parameters include a first T_{Evaluate_out},
the second set of parameters include a second T_{Evaluate_out}, and
the processor is further configured to determine the radio link failure for the second subset of slots based on the second reception quality using the second T_{Evaluate_out}.

12. The UE of claim 7, wherein:
the set of RLM RSs includes a first and a second RLM RS,
the first set of parameters includes a first value and a second value corresponding to a first parameter from the first set of parameters, and
the first and second values correspond to the first and second RLM RSs, respectively.

13. A base station (BS) comprising:
a transceiver configured to:
transmit information for a set of radio link monitoring (RLM) reference signals (RSs) and a first set of parameters associated with an evaluation of the set of RLM RSs, wherein the set of RLM RSs corresponds to a first subset of slots from a set of slots on a cell; and
transmit the set of RLM RSS,
wherein a radio link failure for a second subset of slots from the set of slots on the cell is based on a second reception quality for the second subset of slots, that is based on a first reception quality for a RLM RS from the first set of RLM RSs and an adjustment value, is below a reception quality threshold for a second time period,
wherein the first subset of slots does not include time-domain resources indicated for simultaneous transmission and reception on the cell, and
wherein the second subset of slots includes time-domain resources indicated for simultaneous transmission and reception on the cell.

14. The BS of claim 13, wherein:
the second reception quality is scaled based on a reception power of the RLM RS with the adjustment value, and
the adjustment value is an offset value.

15. The BS of claim 13, wherein:
a radio link failure for the first subset of slots is based on a determination that the first reception quality is below a first reception quality threshold for a first time period; and
a radio link failure for the cell is based on the determinations of the radio link failures for the first subset of slots and for the second subset of slots.

16. The BS of claim 13, wherein:
the transceiver is further configured to transmit a second set of parameters associated with the second subset of slots from the set of slots on the cell,
the first set of parameters include a first BLERₒᵤₜ,
the second set of parameters include a second BLERₒᵤₜ, and
the radio link failure for the second subset of slots is further based on the second reception quality and the second BLERₒᵤₜ.

17. The BS of claim 13, wherein:
the transceiver is further configured to transmit a second set of parameters associated with the second subset of slots from the set of slots on the cell,
the first set of parameters include a first T_{Evaluate_out},
the second set of parameters include a second T_{Evaluate_out}, and
the radio link failure for the second subset of slots is further based on the second reception quality and the second T_{Evaluate_out}.

18. The BS of claim 13, wherein:
the set of RLM RSs includes a first and a second RLM RS,
the first set of parameters includes a first value and a second value corresponding to a first parameter from the first set of parameters, and
the first and second values correspond to the first and second RLM RSs, respectively.
